(19) United States
(12) Patent Application Publication
(10) Pub. No.: US 2016/0322638 A1
(43) Pub. Date: Nov. 3, 2016

(54) HEAT-TREATED POLYMER COATED ELECTRODE ACTIVE MATERIALS

(71) Applicant: A123 Systems LLC, Waltham, MA (US)

(72) Inventors: Michael Erickson, Plano, TX (US); Konstantin Tikhonov, Pleasanton, CA (US)

(21) Appl. No.: 15/141,601

(22) Filed: Apr. 28, 2016

Related U.S. Application Data
(60) Provisional application No. 62/156,154, filed on May 1, 2015.

(51) Int. Cl. H01M 4/62; H01M 4/131; H01M 10/058; H01M 4/485; H01M 10/0525; H01M 4/04; H01M 4/1391

(52) U.S. Cl. CPC H01M 4/62; H01M 4/0404; H01M 4/0471; H01M 4/0423; H01M 4/131; H01M 4/1391; H01M 4/485; H01M 10/0525; H01M 10/058; H01M 2004/027

(57) ABSTRACT

A material and method for a heat-treated polymer coated electrode active material for use in a lithium-ion battery is provided. The heat-treated polymer coated electrode active material includes a heat-treated polymer coating present as a direct conformal layer on at least a portion of the outer surface of the electrode active material. The surface-treated electrode active material improves the capacity retention, reduces gassing, and improves cycle life.

### CROSS REFERENCE TO RELATED APPLICATION

This application claims priority to U.S. Provisional Application No. 62/156,154, entitled “Heat-Treated Polymer Coated Electrode Active Materials”, filed May 1, 2015, which is hereby incorporated by reference in its entirety for all purposes.

### FIELD OF THE INVENTION

This application relates to materials and methods for battery electrodes, materials used therein, and electrochemical cells using such electrodes and methods of manufacture, such as lithium secondary batteries.

### BACKGROUND AND SUMMARY

Lithium-ion (Li-ion) batteries are a type of rechargeable battery which produce energy from electrochemical reactions. In a typical Li-ion battery, the cell may include a positive electrode, a negative electrode, an ionic electrolyte solution that supports the movement of ions back and forth between the two electrodes, and a porous separator which allows ion movement between the electrodes and ensures that the two electrodes do not touch.

Li-ion batteries may comprise metal oxides for the positive electrodes (herein also referred to as a cathode) and carbon/graphite or lithium titanate (herein also referred to as lithium titanium oxide) for the negative electrodes (herein also referred to as an anode), and a salt in an organic solvent, typically a lithium salt, as the ionic electrolyte solution. The anode, during charge, intercalates lithium-ions from the cathode and during discharge, releases the ions back to the cathode.

Some surface activity of electrode active materials used in positive and negative electrodes of electrochemical cells, such as lithium batteries, can have deleterious effects. For example, electrolytes may decompose on a surface of the negative electrode and/or positive electrode. This decomposition may be due to the catalytic activity of the surface of the electrode active material, electrical potential at this surface, and/or a presence of specific functional groups (e.g., hydroxyl and oxygen groups) on the surface of the electrode active material. This electrolyte decomposition and other undesirable surface reactions on the surface of the electrode active material may result in a high resistance causing capacity fade, poor rate performance, and other characteristics. Furthermore, substantial gas generation may occur inside a sealed case of a battery and cause swelling and potentially unsafe conditions. Many positive electrode active materials and negative electrode active materials can exhibit such deleterious activity. Nickel containing materials and titanium containing materials, such as lithium titanium oxide (LTO), are particularly prone to gas generation when used with many different electrolytes.

The inventors herein have recognized the above issues and provided a heat-treated polymer coated electrode active material to address in part the above issues. Provided herein are heat-treated polymer coated electrode active materials comprising a heat-treated polymer coating on at least a portion of the surface of the electrode active material. Heat-treated may include both treatment in air and/or pyrolysis. The heat-treated polymer coating forms upon heat-treatment of a polymer, which is in direct contact with a surface of the electrode active material. The heat-treated polymer coating is present as a conjugated ring system, for example as conformal conjugated graphene type structures, on the surface of the electrode active material.

In one example, the heat-treated polymer coated electrode active material may be used in a Li-ion cell. The Li-ion cell comprising the heat-treated polymer coated electrode active material may provide increased cycle life and capacity retention, and reduced gassing in comparison to uncoated electrode active materials.

It will be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF DRAWINGS

FIG. 1 is a schematic illustration of a proposed mechanism of solvent reduction on a surface of an electrode active material, for example lithium titanate.

FIG. 2 is an example schematic illustration of a heat-treated polymer coated electrode active material, in accordance with certain embodiments.

FIG. 3 is an example method for preparing a heat-treated polymer coated electrode active materials, in accordance with certain embodiments.

FIG. 4 is a schematic example for fabricating an electrode from a heat-treated polymer coated electrode active material, in accordance with some embodiments.

FIG. 5A is a structure of poly(acrylonitrile).

FIGS. 5B and 5C are proposed structures of heat-treated poly(acrylonitrile).

FIG. 6 is an example method for preparing heat-treated polymer coated electrode active materials using a phase separation approach, in accordance with certain embodiments.

FIGS. 7A and 7B are scanning electron micrographs of heat-treated poly(acrylonitrile) coated lithium titanate, prepared in accordance with certain embodiments.

FIGS. 8A and 8B is a Fourier transform infrared spectra illustrating changes in peak intensity during preparation of heat-treated polymer coated electrode active materials, in accordance with certain embodiments.

FIG. 9A is a structure of parylene.

FIG. 9B is a proposed structure of heat-treated parylene.

FIG. 10 is an example method for preparing heat-treated polymer coated electrode active materials using a gas phase deposition approach, in accordance with certain embodiments.

FIG. 11 is a Fourier transform infrared spectra illustrating the presence of parylene on the surface of the electrode active materials, in accordance with certain embodiments.

FIG. 12 illustrates capacity retention of Li-ion cells including parylene coated LTO wherein the parylene is not heat-treated and the parylene coating thickness is varied.

FIGS. 13A and 13B are scanning electron micrographs of uncoated LTO and parylene coated LTO, prepared in accordance with certain embodiments.

FIGS. 14A and 14B are scanning electron micrographs of heat-treated parylene coated lithium titanate, prepared in accordance with certain embodiments.

FIG. 15 shows an example schematic representation of an electrochemical cell.

FIG. 16 illustrates capacity retention of Li-ion cells at 40° C. including a heat-treated poly(acrylonitrile) coated electrode active material in comparison to control cells.

FIG. 17 illustrates capacity retention of Li-ion cells at 50° C. including a heat-treated poly(acrylonitrile) coated electrode active material in comparison to control cells.

FIG. 18 illustrates capacity retention of Li-ion cells at 40° C. including a heat-treated parylene coated electrode active material in comparison to control cells.

FIG. 19 illustrates capacity retention of Li-ion cells at 50° C. including a heat-treated parylene coated electrode active material in comparison to control cells.

FIGS. 20A and 20B are schematic top and side views of a prismatic electrochemical cell, in accordance with certain embodiments.

FIG. 20C is a schematic representation of an electrode stack in a prismatic electrochemical cell, in accordance with certain embodiments.

FIGS. 21A and 21B are schematic top and side views of a wound electrochemical cell, in accordance with certain embodiments.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific embodiments, it will be understood that these embodiments are not intended to be limiting.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” or “a mixture of” means a combination including at least one of the foregoing elements.

Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly formal sense unless expressly so defined herein.

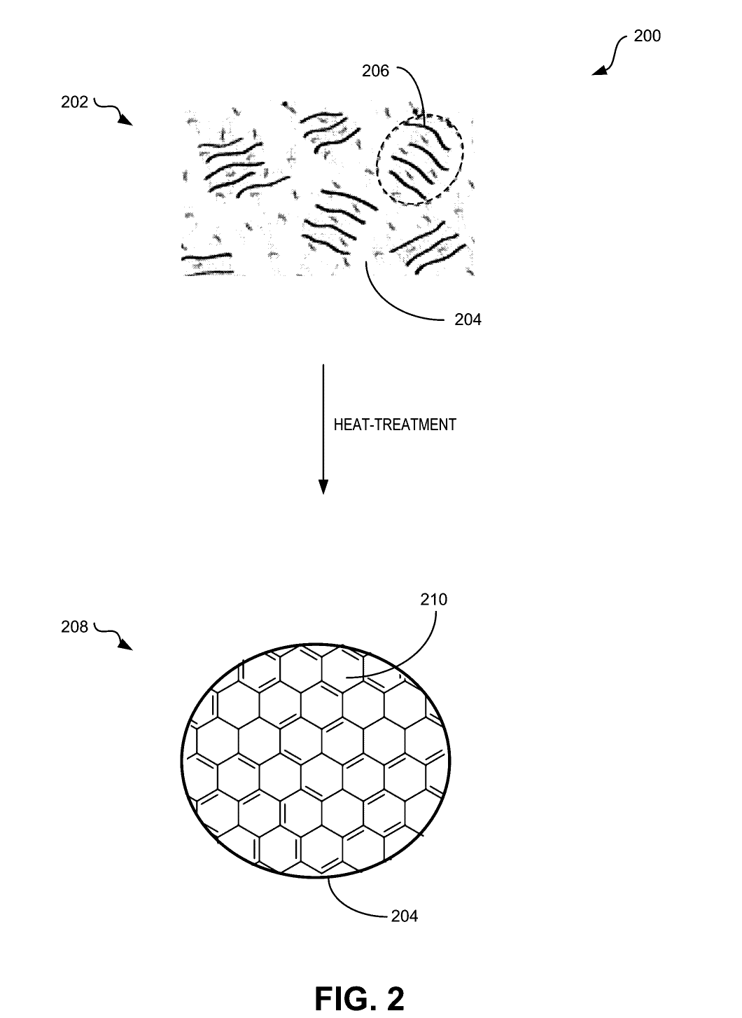

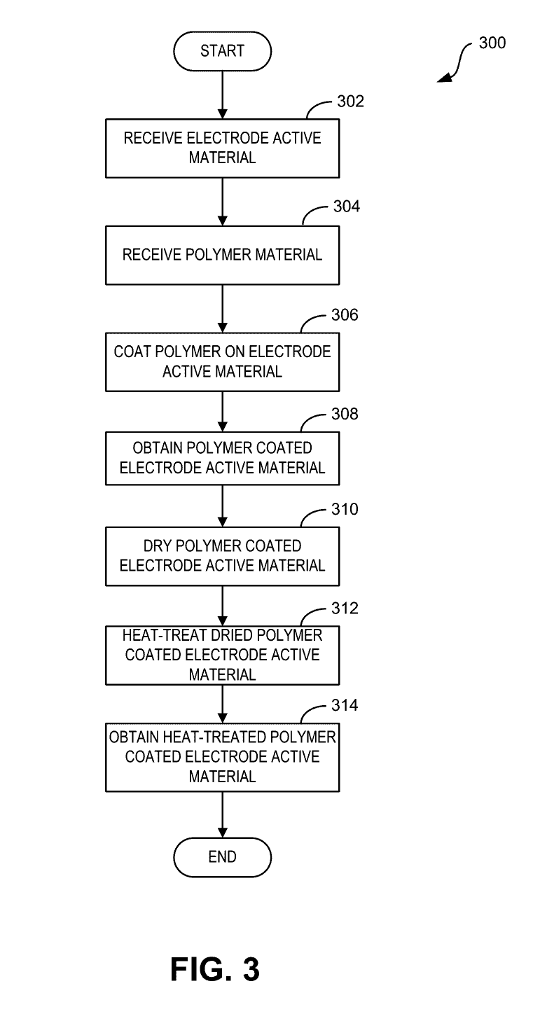

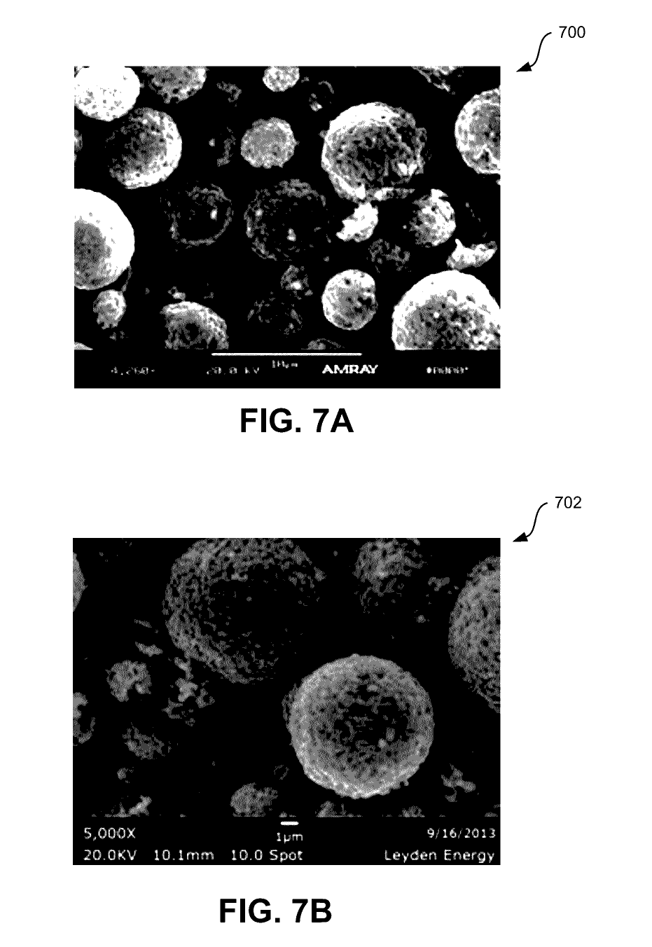

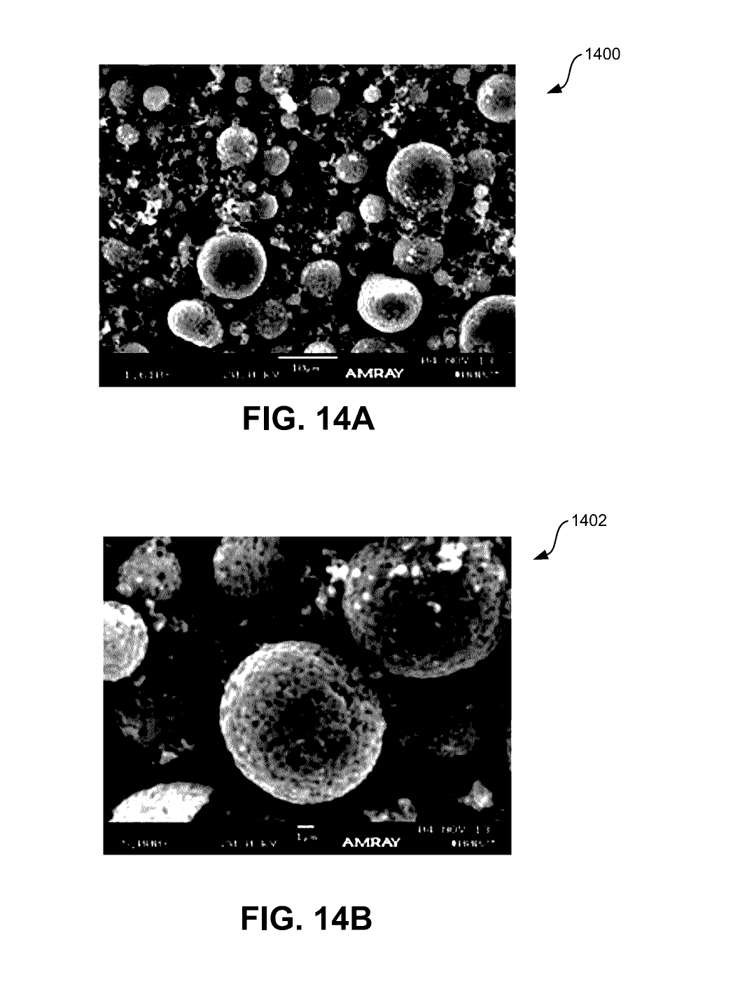

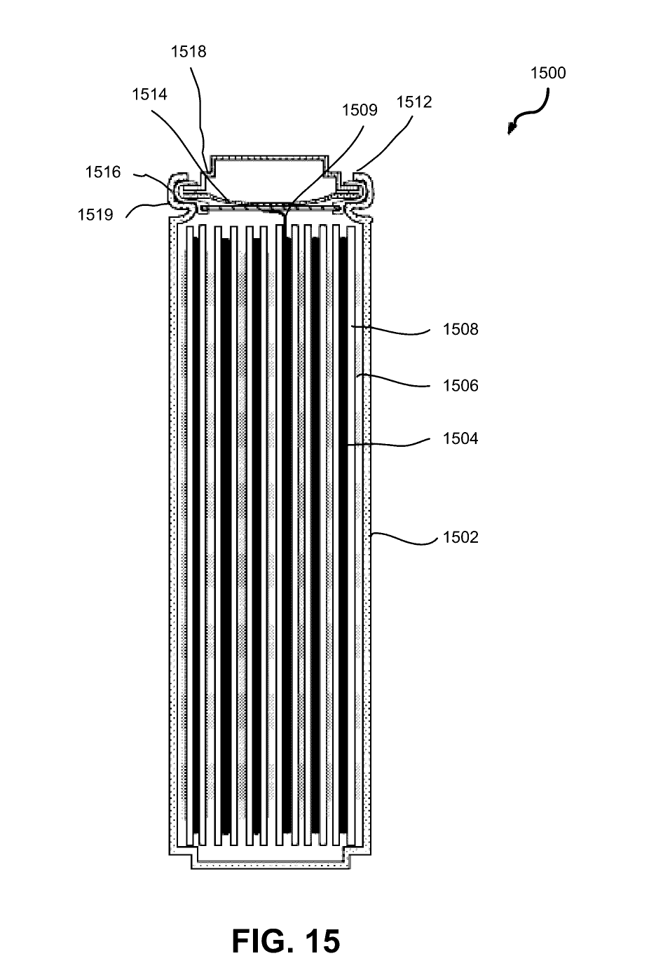

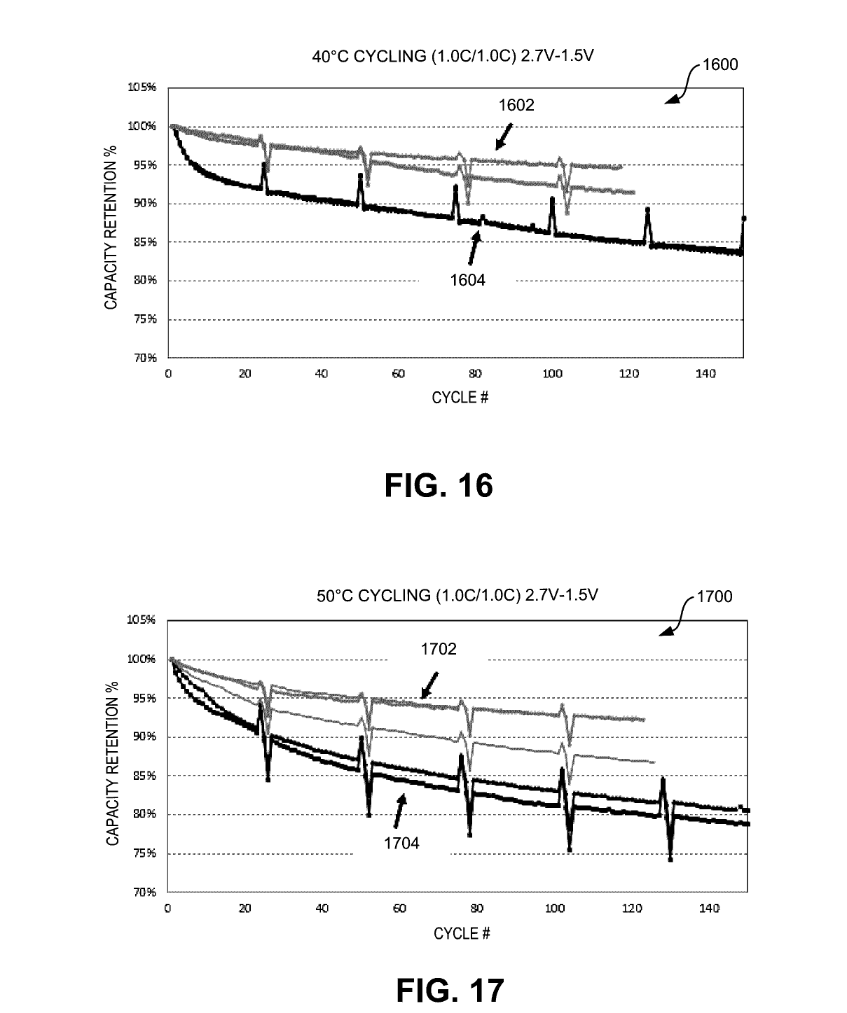

The present disclosure provides materials and method for a heat-treated polymer coated electrode active material for use in a Li-ion cell. The heat-treated polymer coating may be formed by heat-treating a polymer coated electrode active material, as outlined in the example methods provided in FIGS. 3, 6, and 10. Upon heat-treatment, the polymer coating forms a heat-treated polymer coating, such as a conjugated ring system, on the surface of the electrode active material, as illustrated in FIG. 2, wherein the heat-treated polymer coating may be a thin and even coating, as shown in FIGS. 7A, 7B, 14A, and 14B. The heat-treated polymer coating may be in direct contact with the surface of the electrode active material. Electrochemical cells, examples illustrated in FIGS. 15, 20A, 20B, 20C, 21A, and 21B, comprising an electrode including the heat-treated polymer electrode active material may improve the capacity retention and cycle life, and reduce gassing, as shown in FIGS. 16 through 19.

Heat-treated polymer coatings for use with electrode active materials, for example lithium titanate, may improve lithium-ion (Li-ion) cell high temperature performance as well as gassing in comparison to uncoated electrode active materials. Polymer types which undergo transformations to conformal conjugated ring structures, such as conjugated graphene type structures, after heat treatment may be used to provide heat-treated polymer coatings. The polymers provide at least one double bond in a ring structure upon heat-treatment.

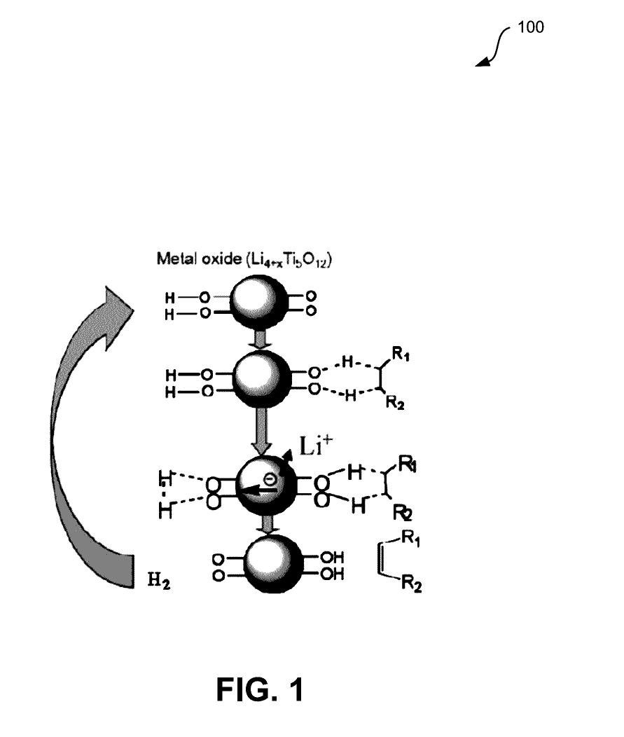

The heat-treated polymer coating may provide an electrically conductive coating to improve particle-to-particle and overall electrode electrical conductivity, thereby enhancing the rate capability and minimizing impedance build-up over the life of the cell. The heat-treated polymer coating may form a conformal coating, wherein the coating is in direct contact with at least a portion of a surface of the electrode active material. The heat-treated polymer coating may significantly reduce direct electrolyte interaction with the electrode active material surface. Without wishing to be bound by theory, the coating may block the theoretical gassing mechanisms, for example as described with reference to FIG. 1 below. Blocking the theoretical gassing mechanisms may reduce cell swelling and minimize gains in impedance. The heat-treated polymer coating is chemically stable and shows resistance to cathodic processes which may be present in electrochemical cells.

Some catalytic activity of the active materials used in positive and negative electrodes of lithium batteries may have deleterious effects. For example, battery degradation is often a result of electrolyte decomposition that takes place at the anode and/or the cathode, possibly due to the catalytic activity of the active material surface or presence of a specific functional group. The decomposition of the electrolyte results in increased impedance and gas generation, which may lead to degradation of the battery.

For example, it is believed that metal oxides and mixed metal oxides of nickel, cobalt, aluminum, and/or manganese catalyze oxidation of the electrolyte. Specifically, swelling of lithium nickel aluminum oxide (NCA) pouch cells is believed to be, at least partially, due to the presence of hydroxide groups on the electrode active surface of the pouch cells, causing oxidation of the electrolyte.

Further, it has been shown that some anode materials, such as lithium titanate (LTO), catalyze the decomposition of the electrolyte. As discussed above, the decomposition of the electrolyte may decrease the useful life of the battery. In addition, the performance of the material or battery may be impaired by traces of moisture. Reducing or fully eliminating this moisture can be beneficial.

Turning to FIG. 1, a schematic illustration of a proposed mechanism of electrolyte decomposition 100 involving hydroxide groups on the electrode active material surface is shown. The hydroxide group catalyzes the removal of hydrogen, H₂, from electrolyte components, decomposing the electrolyte liquid components. While this example shows the release of H₂ from the decomposition of solvents, other gaseous products may be released as well. While this example utilizes lithium titanate, other electrode active materials used in lithium-ion batteries may include other proposed mechanisms. Other electrode active materials are often imparted by surface species that introduce undesirable effects in the functioning or fabrication of the battery.

In the example in FIG. 1, lithium titanate (herein also referred to as Li₄₊ₓTi₅O₁₂ and LTO) reduces solvent compounds on the surface of the LTO. Without wishing to be bound by a particular theory, it is believed that metal oxides of nickel, cobalt, aluminum, titanium, and manganese catalyze the decomposition of electrolyte components and electrolyte solvents. For example, carbonates, such as ethylene carbonate (EC), dimethyl carbonate (DMC), methyl ethyl carbonate (MEC), diethyl carbonate (DEC), and solvents that are commonly used for battery electrolytes, can oxidize on the surface of many metal oxides at high potentials (e.g. greater than 4.0V, 4.5V, or 5.0V.) Such potentials are common for many positive electrodes. Solvents may also be reduced on the surface of the metal oxides at potentials less than about 2.0V versus Li potential. Examples of anodes based on metal oxides are anodes comprising a lithiated metal oxide, wherein the metal oxide may be titanium oxide, tin oxide, niobium oxide, vanadium oxide, zirconium oxide, indium oxide, iron oxide, copper oxide, and mixed metal oxides.

The disclosed embodiments help to overcome these problems by coating the electrode active material having a heat-treated polymer coating, thereby preventing or at least minimizing a direct contact between the surface of the electrode active material and various components of the electrolyte, for example the solvents, while allowing for charge carrying ions to pass. The heat-treated polymer coated electrode active material may be formed by depositing a polymer (or monomer which is polymerized to form the polymer coating) onto the electrode active material, and then heat-treating the polymer to form conjugated ring structures which forms the heat-treated polymer coating. The heat-treated polymer coating operates as a barrier between the electrode active material and the electrolyte. As a result, a less reactive surface of the electrode active material is exposed to the electrolyte instead of a more reactive surface of the electrode active material.

Turning to FIG. 2, an example schematic illustration 200 of the heat-treated polymer coated electrode active material, in accordance with certain embodiments, is shown. The polymer 206 is coated on the surface 204 of the electrode active material, forming a polymer coated electrode active material 202. The polymer coated electrode active material 202 then undergoes heat-treatment to form a heat-treated polymer coating 210, for example conjugated ring structures, on the surface 204 of the electrode active material, forming the heat-treated polymer coated electrode active material 208. The heat-treated polymer coating is in direct contact with the surface of the electrode active material. Thus, a conformal coating is provided on the surface of the electrode active material wherein the conformal coating is a heat-treated polymer coating.

In some embodiments, polymers which are known to form conjugated ring structures after heat-treatment may be used for the heat-treated polymer coating. The heat-treated polymer coating may be formed by heat-treating a polymer coating on the surface of the electrode active material, for example, the outer surface of the electrode active material. The polymer coating may be formed using a polymer or a monomer, wherein the monomer is polymerized to form a polymer. In one example, polymers and/or monomers, wherein a monomer is a molecule that may be bonded to other molecules to form a polymer, comprising a backbone or side chain aromatic ring structure which may form a conjugated ring system after heat-treatment may be used. In another example, polymers and/or monomers comprising an appropriate unsaturated functional group which may form a conjugated ring system after heat-treatment may be used. The polymer may be selected from polymers comprising an acrylate, acrylamide, methacrylate, methacrylamides, vinyl ester, or vinyl amide functional group. In one example, the polymer may be poly(acrylonitrile). In another example, the polymer may be parylene. The parylene may be formed from appropriate dimers during gas phase deposition, as illustrated in reactions 1 through 4 below:

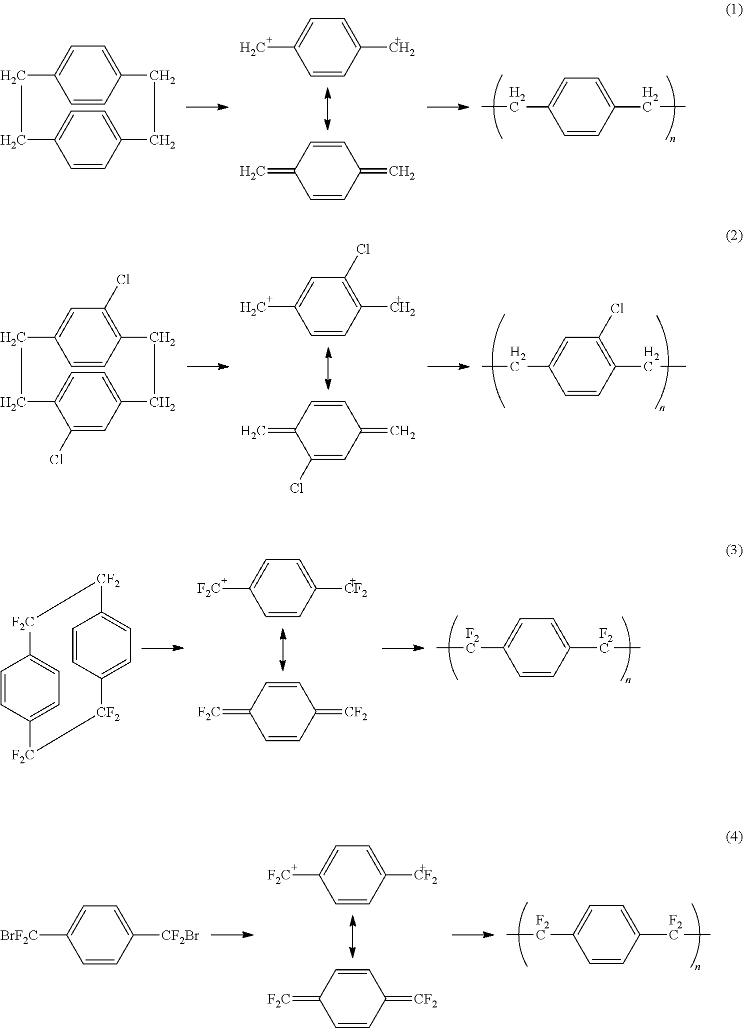

During the subsequent heat-treatment of the parylene coated electrode active material to form the heat-treated polymer coated electrode active material, the halogen may disappear.

The heat-treated polymer coating may comprise a conjugated ring structure. The heat-treated polymer coating may include a ring structure with at least one double bond present. The double bond may be between two of the same elements (for example a C═C bond) or between two different elements (for example a C═N bond). In some examples, the conjugated ring structure may be aromatic (for example a benzene ring derivative structure). The conjugated ring structure may comprise a ring including at least four members. For example, the conjugated ring structure may include a four membered ring, a five membered ring, a six membered ring, a seven membered ring, or an eight membered ring. In another example, the conjugated ring structure may include conformal conjugated graphene type structures.

Polymers which do not form these types of structures may not provide a heat-treated polymer coating which improves the electrode active materials performance when used in a Li-ion cell. For example, polymers which are saturated and/or undergo decomposition into gaseous products during heat-treatment may not form the conjugated ring structure coating on an electrode active material.

Turning to FIG. 3, an example method 300 is provided to prepare heat-treated polymer coated electrode active materials. The method outlines a general process which may be followed to obtain the heat-treated polymer coated electrode active materials. The heat-treated polymer coated electrode active materials may be used to fabricate electrodes for use in Li-ion cells. In some embodiments, the heat-treated polymer coated electrode active materials may receive further surface treatments, such as a gaseous treatment following electrode fabrication or assembly into a Li-ion cell.

At 302, the method may include receiving the electrode active material. In one example, the electrode active material may be a metal oxide active material capable of lithiation and delithiation. For example, the electrode active materials may be a lithiated metal oxide. In one example, the electrode active material may be lithium titanate. The received electrode active material may be present in a form ready for fabrication into an electrode. For example, the electrode active material may be present as secondary particles comprising primary particles of the electrode active material. In some embodiments, the electrode active material may be present in the form of a powder or as particulates. In some embodiments, the electrode active material primary particles are loosely associated with each other and the secondary particles are largely not present. Primary particles of the electrode active material may be less than 1 μm in size or less than 0.5 μm in size. Secondary particles may be less than about 1 μm, or 5 μm, or 7.5 μm, or 10 μm. The larger secondary particles may be easier to process and have a smaller active surface area. The smaller surface area may result in less degradation over time. The smaller secondary particle sizes may have a benefit of a shorter diffusion path and higher rate capability. In some embodiments, the electrode active material may be doped with metals such as molybdenum, zirconium, or others, or may be doped with carbon or carbon nanotubes to increase the electronic conductivity. In another embodiment, the electrode active material may optionally include a preliminary surface treatment to minimize the reaction of the metal oxide with water and reduce the formation of hydroxide groups on the surface of the electrode active material. For example, LTO may include the preliminary surface treatment to reduce the formation of LiOH on the surface of the LTO. In yet another embodiment, the preliminary surface treatment may include heat treating the electrode active material to remove surface groups and impurities. For example, heat treating may be done at 200° C. to 800° C. under vacuum, or in air, or in gas (e.g. nitrogen or argon).

At 304, the method may include receiving the polymer material, herein also referred to as polymer. In this example, the polymer may include a structural element or functional group which will form a ring structure during a subsequent heat-treatment step. For example, the polymer may be poly(acrylonitrile) or parylene. In other examples, the polymer may include an alcohol functional group and a carboxylic acid functional group. The polymer material may be received fully synthesized or be prepared from a known synthetic route.

At 306, the method may include coating the polymer on the surface of the electrode active material. The coating method may be chosen based upon the polymer structural features and commonly known methods employed for coating the polymer onto a surface of other materials. For example, phase separation, gas phase deposition, or other film deposition methods may be used to coat the polymer on the surface of the electrode active material. As used herein, coating the polymer may be referred to as depositing the polymer. In one example, the polymer may be deposited on the surface of the electrode active material using a phase separation approach to form the coated electrode active material. In another example, the polymer may be deposited on the electrode active material using a gas phase deposition approach to form the polymer coated electrode active material. In some embodiments, coating the polymer on the electrode active material may include a polymerizing step depending upon the deposition method employed. For example, during a gas phase deposition, the polymer may be vaporized to a monomer or dimer and deposited on the surface of the electrode active material. The monomer or dimer may then be polymerized to form the polymer coated electrode active material.

At 308, the method may include obtaining the polymer coated electrode active material.

At 310, the method may include drying the polymer coated electrode active material. For example, the polymer coated electrode active material may be dried at a temperature to remove any residual solvent molecules. For example, the coated electrode active material may be dried at a temperature above the boiling point of the solvent molecules. The polymer coated electrode active material may be dried under vacuum, or gas (e.g. nitrogen or argon). In some examples, coating the electrode active material under vacuum using gas phase deposition may eliminate or greatly reduce the need for drying step 310.

At 312, the method may include heat-treating the dried polymer coated electrode active material from step 310, or alternatively heat-treating the polymer coated electrode active material from step 308. Heat-treating may include heat treatment in air. Heat-treating may be done at a temperature between 200° C. to 600° C. The heat-treatment temperature may be chosen based on the polymer chosen. The temperature for heat-treatment may be chosen to be lower than the carbonization or decomposition temperature of the polymer. Heat treatment conditions depend on many factors. Lower temperatures, for example in the range of 150° C. to 300° C., in air or other oxidizing atmosphere may partially oxidize and carbonize the polymer coating. Higher temperature treatments, for example pyrolysis, may generally be carried out in inert atmosphere to avoid burning off the polymer. For example, materials can be treated under vacuum or in argon or nitrogen atmosphere at 500° C. to 900° C. The higher limit of the temperature range is defined by the stability of the electrode active material. Heat treatment may also consist of several steps, such as heat treating the coated material in air at relatively moderate temperature, such as 250° C., followed by higher temperature treatment in inert atmosphere, such as under argon at 800° C. The benefits of doing the heat treatment in air are the lower equipment cost, the simplicity, and lower energy use for the process. The partial oxidation of the polymer coating may also be beneficial for its properties, for example, making it more hydrophilic and better wetted by solvents or electrolytes. Further, heat treatment in air may also remove some impurities. On the other hand, higher temperature treatments may result in coatings with higher carbon content and, when done at sufficiently high temperatures, in a high degree of graphitization. A high degree of graphitization may be beneficial due to higher electrical conductivity of the coating.

At 314, the method includes obtaining the heat-treated polymer coated electrode active material. The method may then end. Without wishing to be bound by theory, the heat-treated polymer coating may include chemical bonds between the electrode active material and the heat-treated polymer coating due to the surface reactivity of the electrode active material. For example, the surface of LTO is reactive and bonds between the titanium on the surface of the LTO and the oxygen and carbon of the heat-treated polymer may form. In another example, the heat-treated polymers may react and form bonds with the hydroxide groups present on the surface of the electrode active material. The heat-treated polymer coated electrode active material may then be used to fabricate and electrode for use in an electrochemical cell. The heat-treated polymer coated electrode active material includes a conjugate ring structure coating on the surface of the electrode active material which reduces contact between an electrolyte and the surface of the electrode active material in an electrochemical cell. The use of a heat-treated polymer coated electrode active material to fabricate an electrode for use in a Li-ion cell showed an unexpected increase in cycle life and capacity retention, and reduced gassing in comparison to a Li-ion cell comprising an electrode including an uncoated electrode active material.

For example, a method for preparing a heat-treated polymer coated electrode active material, as outlined in FIG. 3, is provided. The method may comprise receiving an electrode active material, receiving a polymer material, coating the polymer on the electrode active material and heat-treating the polymer coated electrode active material. Coating the polymer on the electrode active material may form a polymer coated electrode active material. Coating the polymer may be done using phase separation or gas phase deposition. Heat-treating the polymer coated electrode active material forms a heat-treated polymer electrode active material. Heat-treating the polymer coated electrode active material may be done at a temperature less than 600° C. The heat-treatment may be done in air. The heat-treated polymer electrode active material may have a heat-treated polymer coating having a conjugated ring structure, for example as described at FIG. 2. The polymer coated electrode active material may be dried prior to heat-treating the polymer coated electrode active material to remove any residual solvent molecules. In one example, the polymer may be poly(acrylonitrile). In another example, the polymer may be parylene.

The method may further comprise preparing a slurry formulated for coating onto a current collector to form an anode. For example, preparing the slurry may comprise the heat-treated polymer coated electrode active material wherein the slurry further comprises a polymer binder selected from the group consisting of polyacrylonitrile, poly(methylmethacrylate), poly(vinyl chloride), polyvinylidene fluoride, poly(vinylidene fluoride-co-hexafluoropropene), polyacrylic acid, styrene butadiene rubber, carboxymethylcellulose, and copolymers thereof. The method may then comprise coating the slurry onto the current collector and drying the slurry on the current collector, thereby forming the anode.

The method may further comprise fabricating a lithium-ion battery. The lithium-ion battery may comprise the anode formed as described above, including the heat-treated polymer coated electrode active material, a cathode, and a separator positioned between the anode and the cathode. Further, an electrolyte being in ionically conductive contact with the anode and the cathode and permeating the separator may be included in the lithium-ion battery. The electrolyte may comprise at least one salt and at least one non-aqueous solvent.

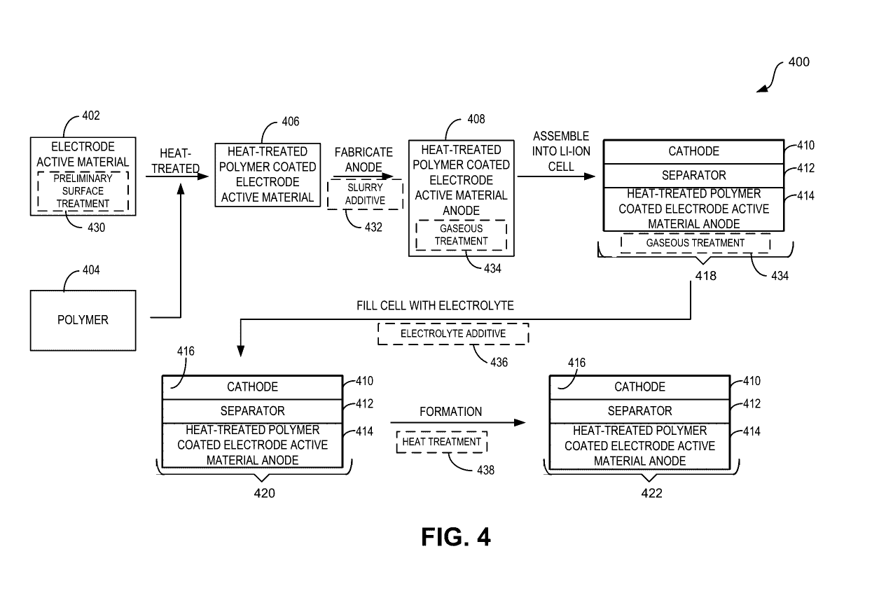

Turning to FIG. 4, an example schematic 400 for fabricating an electrode from an electrode active material, such as LTO, is shown. The example shown includes a heat-treated polymer coated electrode active material, in accordance with certain embodiments. The heat-treated polymer coated electrode active material provides an electrode active material which may be fabricated into an anode for use in Li-ion batteries, which is capable of providing increased cycle life and capacity retention, and reduced gassing in comparison to uncoated electrode active materials.

Forming heat-treated polymer coated electrode active materials may be performed prior to using the electrode active materials for fabricating the electrodes and cells, as described below with reference to FIG. 4, and following synthesis of the electrode active materials. Example schematic 400 may include optional surface treatments in addition to the heat-treated polymer coating, as described in FIG. 2. The stage at which the coating, herein also referred to as surface layers, may be formed is important as different kinds of surface layers may be produced. Surface layers can be fabricated on the materials during material manufacturing process: as the active materials are being made from the precursors, before, after or during the heat treatment of the particles following the synthesis. In some embodiments, other surface layers may be created during the slurry preparation and heat materials are exposed to during electrode coating. In other embodiments, yet other layers may be created after the cells are assembled by exposing the active material structures to reactive gas or liquid. Finally, surface layers can be produced after cell assembly through a reaction of the active materials with electrolyte components: salts, solvents and additives. For purposes of this disclosure, forming surface layers on electrode active material structures may also be referred to as surface treatment of the electrode active material structures.

Turning to FIG. 4 at 402, the electrode active material may be obtained. In one example, the electrode active material is lithium titanate, LTO. In other examples, the electrode active material may be another metal oxide active material capable of lithiation and delithiation. The obtained electrode active material may be present in a form ready for fabrication into an electrode. For example, the electrode active material may be present as secondary particles comprising primary particles of the electrode active material. In some embodiments, the electrode active material may be present in the form of a powder or as particulates. In some embodiments, the electrode active material primary particles are loosely associated with each other and the secondary particles are largely not present. Primary particles of the electrode active material may be less than 1 μm in size or less than 0.5 μm in size. Secondary particles may be about 1 μm, or 5 μm or 7.5 μm or 10 μm. Larger secondary particles are easier to process and have smaller active surface area. Smaller surface area may result in less degradation over time. Smaller secondary particle sizes have a benefit of a shorter diffusion path and higher rate capability. In some embodiments, the electrode active material is doped with metals such as molybdenum, zirconium or others, or is doped with carbon or carbon nanotubes to increase its electronic conductivity.

In one example, the electrode active material may optionally include a preliminary surface treatment 430. For example, the preliminary surface treatment 430 may be done to minimize the reaction of LTO with water and reduce the formation of LiOH on the surface. In one example, the preliminary surface treatment may be done using silanes, such as oxy-silanes. In another example, the preliminary surface treatment may include heat treating the electrode active material to remove surface groups and impurities. For example, the heat treating may be done at 200° C. to 800° C. under vacuum, or in air, or in gas (e.g. nitrogen or argon). In yet another example, the preliminary surface treatment may include an inorganic surface treatment, for example aluminum phosphate, which may form surface structures on the surface of the electrode active material. For example, in the case of LTO treated with aluminum phosphate, LiₓAl_{y}Ti_{z}O₂ structure may form on the surface of the electrode active material.

Proceeding from 402, the polymer 404 may be coated on the electrode active material 402 and then heat-treated to form a heat-treated polymer coated electrode active material 406. In one example, the polymer may be poly(acrylonitrile) coated on the surface of the electrode active material using a phase separation technique and then heat-treated to form a heat-treated poly(acrylonitrile) electrode active material. In another example, the polymer may be parylene coated on the surface of the electrode active material using a gas phase deposition technique and then heat-treated to form a heat-treated parylene electrode active material. Alternatively, the electrode active material may be used to fabricate an anode for use in a Li-ion cell with no heat-treated polymer coating. Thus, the provided electrode active material may be used without the heat-treated polymer coating in accordance with the disclosed embodiments, for example, to prepare a control cell with an uncoated LTO anode.

Referring back to 402, the provided electrode active material may be coated with the polymer 404 and then undergo heat-treatment to form a heat-treated polymer coated electrode active material, as described in FIGS. 2 and 3 above. The electrode active material 402 may be coated with a polymer 404, wherein the polymer forms a conformal coating on the surface of the electrode active material. The polymer coated electrode active material is then heat-treated to form the heat-treated polymer coated electrode active material. The heat-treated polymer coated electrode active material 406 may then be fabricated into an anode comprising the heat-treated polymer coated electrode active materials at 408. Prior to fabricating the electrode, the heat-treated polymer coated electrode active material may be pre-mixed with one or more conductive additives, such as graphite, acetylene black, carbon nanotubes, ceramics, other electrode active materials, and the like.

At 408, the heat-treated polymer coated electrode active material may be fabricated into an anode and may include other processing steps. For example, the anode may include electrode active materials and a current collector. In some embodiments, the anode may comprise either a metal selected from the group consisting of Li, Si, Sn, Sb, Al, and a combination thereof, or a mixture of one or more anode active materials in particulate form, a binder (in certain cases a polymeric binder), optionally an electron conductive additive, and at least one organic carbonate. Examples of useful anode active materials include, but are not limited to, lithium metal, carbon (graphites, coke-type, mesocarbons, polyacenes, carbon nanotubes, carbon fibers and the like). Anode-active materials also include lithium-intercalated carbon, lithium metal nitrides such as Li_{2.6}Co_{0.4}N, metallic lithium alloys such as LiAl, Li₄Sn, or lithium-alloy-forming compounds of tin, silicon, antimony, or aluminum. Further included as anode-active materials are metal oxides such as titanium oxides, iron oxides, or tin oxides.

For example, fabricating the electrode may include several suboperations such as mixing the LTO electrode active material into a slurry, coating the slurry onto a conductive substrate, drying the coating, compressing the coating, and calendering. In one example, the slurry may be coated on both sides of the current collector. In another example, the slurry may be coated on one side of the current collector. Further, the slurry may comprise non-aqueous liquids, and additives, such as a binder or a conductive additive.

Suitable conductive additives for the positive electrode and negative electrode composition include carbons such as coke, carbon black, carbon nanotubes, carbon fibers, and natural graphite, metallic flake or particles of copper, stainless steel, nickel or other relatively inert metals; conductive metal oxides such as titanium oxides or ruthenium oxides; or electrically-conductive polymers such as polyacetylene, polyphenylene and polyphenylenevinylene, polyaniline or polypyrrole. Additives may include, but are not limited to, carbon fibers, carbon nanotubes, and carbon blacks with a surface area below about 100 m²/g, such as Super P and Super S carbon blacks available from MMM Carbon in Belgium. Other conductive carbons such as Ketjenblack with surface area up to 1000 m²/g may also be used.

Suitable binders may include, but are not limited to, polymeric binders. For example, a polymer binder selected from the group consisting of polyacrylonitrile, poly(methylmethacrylate), poly(vinyl chloride), polyvinylidene fluoride, poly(vinylidene fluoride-co-hexafluoropropene), polyacrylic acid, styrene butadiene rubber, carboxymethylcellulose and copolymers thereof.

In some embodiments, slurry additives 432 may be optionally incorporated into the slurry which treats the electrode active material. In one example, the slurry additive may comprise silanes added to the slurry, which may chemically react and form a covalently bound silane surface layer to the electrode active material structures. The silanes may reduce the reactivity of the electrode active material structures with respect to the electrolyte. For example, the silane may be an oxy-silane.

In another embodiment, trimethoxy methyl silane, MTMS, may be used to treat LTO while it was still in the powder form and prior to combining LTO structures with a polymer binder. This treatment is different from the one in the above described experiment, where MTMS was introduced into the slurry. The mechanism of forming a surface layer covalently bound to the LTO structures is believed to be the same.

In one example, the heat-treated polymer coated active material may be mixed with a binder and at least one additive in a non-aqueous solvent to form a slurry which is coated onto a current collector. The coated current collector may then be dried and calendered to form the anode comprising the heat-treated polymer coated electrode active material. The anode comprising the heat-treated polymer coated LTO may then be fabricated into a Li-ion cell as illustrated at 418, wherein the Li-ion cell may include cathode 410, separator 412, and the anode comprising the heat-treated polymer coated electrode active material 414. In some embodiments, the Li-ion cell may receive the gaseous treatment 434.

In one embodiment, a gaseous treatment 434 may be performed on the anode following fabrication and drying. In another embodiment, the gaseous treatment 434 may be performed following fabrication of the Li-ion cell and drying, directly prior to filling with electrolyte. In yet another embodiment, the gaseous treatment may not be performed on the anode. The gaseous treatment exposes the available surfaces of the electrochemically active material which are accessible to gaseous reactants to produce the modified surface having improved properties for use in the lithium battery. In one example, the gaseous reactant may have a molecular weight of about 300 g/mol or less. For example, the gaseous reactant may be selected from the group consisting of hydrides, oxides, sulfides, oxysulfides, fluorides, and oxyfluorides of carbon, sulfur, phosphorus and boron. In other examples, a mixture of two or more gaseous reactants may be used. The gaseous reactant may chemically modify the surface of the electrochemically active material that is accessible to the gaseous reactant, thereby producing a modified electrochemically active material having improved properties for use in the Li-ion battery.

Thus, a Li-ion cell comprising a heat-treated polymer coated electrode active material may be provided at 418.

For example, the cathode may be formed by mixing and forming a composition comprising a binder, a conductive additive, solvent, etc. to prepare a slurry wherein the slurry is then coated on a substrate, e.g. a current collector, which is then followed by drying to produce the electrode. Further, such electrode materials may be subjected to roll forming or compression molding to be fabricated into a sheet or pellet, respectively.

In other examples, the cathode active material, herein also referred to as the positive electrochemically active material or the positive electrode active material, is a lithium transition metal phosphate compound having the formula (Li₁₋ₓZₓ)MPO₄, where M is one or more of vanadium, chromium, manganese, iron, cobalt, and nickel, Z is one or more of titanium, zirconium, niobium, aluminum, tantalum, tungsten or magnesium, and x ranges from 0 to 0.05 or Li₁₋ₓMPO₄, wherein M is selected from the group comprising vanadium, chromium, manganese, iron, cobalt, and nickel; and 0≦x≦1.

In yet another example, the positive electrochemically active material is a lithium metal phosphate, for example, lithium iron phosphate. The positive electrochemically active material may be present as powder or particulates with a specific surface area of greater than 5 m²/g, 10 m²/g, or greater than 15 m²/g, or greater than 20 m²/g, or even greater than 30 m²/g.

The suitable positive electrode-active compounds may be further modified by doping with about 5% or less of divalent or trivalent metallic cations such as Fe²⁺, Ti²⁺, Zn²⁺, Ni²⁺, Co²⁺, Cu²⁺, Mg²⁺, Cr³⁺, Fe³⁺, Al³⁺, Ni³⁺, Co³⁺, or Mn³⁺, and the like.

For example, the cathode may comprise a lithium metal phosphate. In one example, the lithium metal phosphate may be lithium iron phosphate, LiFePO₄. Further, the LiFePO₄ may have an olivine structure and be made in the form of very small, high specific surface area particles which are exceptionally stable in their delithiated form.

The current collecting substrate suitable for the positive and negative electrode includes a metal foil and a carbon sheet selected from a graphite sheet, carbon fiber sheet, carbon foam, and carbon nanotube sheet or film. High conductivity is generally achieved in pure graphite and pure carbon nanotube films. Therefore, the graphite and nanotube sheeting should contain as few binders, additives, and impurities as possible in order to realize the benefits of the present embodiments. Carbon nanotubes can be present from about 0.01% to about 99% by weight. The carbon fiber can be in the micron or submicron range. Carbon black or carbon nanotubes may be added to enhance the conductivities of certain carbon fibers. In one embodiment, the negative electrode current collecting substrate is a metal foil, such as copper foil. The metal foil can have a thickness between about 5 and about 300 micrometers.

The carbon sheet current collecting substrate may be in the form of a powder coating on a substrate such as a metal substrate, a free-standing sheet, or a laminate. In other words, the current collecting substrate may be a composite structure having other members such as metal foils, adhesive layers, and such other materials as may be considered desirable for a given application. However, in any event, according to the present embodiments, it is the carbon sheet layer, or carbon sheet layer in combination with an adhesion promoter, which directly interfaces with the electrolyte and is in electrically conductive contact with the electrode surface.

The separator 412 has no particular restriction on the source material or morphology of the separator for the Li-ion cell. Additionally, the separator serves to separate the anode and the cathode so as to avoid their physical contact. The preferred separator has higher porosity, excellent stability against the electrolytic solution, and excellent liquid holding properties. Example materials for the separator may be selected from nonwoven fabric or porous film made of polyolefins, such as polyethylene and polypropylene, or ceramic coated materials.

The Li-ion cell 418 may then be filled with electrolyte 416 (indicated by the hashed lines), to produce a filled Li-ion cell 420. The electrolyte 416 is in intimate contact with the components in the Li-ion cell, as illustrated. The electrolyte may comprise Li salt, organic solvents, such as organic carbonates, and additives. The electrolyte is present throughout the Li-ion cell and in physical contact with the anode 414, cathode 410, and separator 412. The molar concentration of the lithium salt may be between 0.5 and 2.0 mol/L.

Further, the electrolyte may comprise aprotic solvents. For example, the solvent may comprise at least one of cyclic carbonates and linear carbonates. Some examples of cyclic carbonates include ethylene carbonate, propylene carbonate, butylene carbonate, vinylene carbonate, dimethylvinylene carbonate, vinylethylene carbonate, and fluoroethylenecarbonate. In some examples, the cyclic carbonate compounds may include at least two compounds selected from ethylene carbonate, propylene carbonate, vinylene carbonate, vinylethylene carbonate, and fluoroethylene carbonate. Some examples of linear carbonates include dimethyl carbonate, diethyl carbonate, ethyl methyl carbonate, methyl propyl carbonate, dipropyl carbonate, methyl butyl carbonate and dibutyl carbonate. The alkyl group of the linear carbonates can have a straight or branched chain structure. Some examples of other electrolyte solvents include lactones such as γ-valerolactone, γ-butyrolactone, and alpha-angelica lactone; nitriles such as acetonitrile and adiponitrile; linear esters such as methyl acetate, methyl propionate, methyl pivalate, butyl pivalate, hexyl pivalate, octyl pivalate, dimethyl oxalate, ethyl methyl oxalate, and diethyl oxalate; amides such as dimethylformamide; compounds having an S═O bonding such as glycol sulfite, propylene sulfite, glycol sulfate, propylene sulfate, divinyl sulfone, 1,3-propane sultone, 1,4-butane sultone, and 1,4-butanediol dimethane sulfonate; other solvents such as tetrahydrofuran, 2-methyl tetrahydrofuran, tetrahydropyran, dimethoxyethane, dimethoxymethane, ethylene methyl phosphate, ethyl ethylene phosphate, trimethyl phosphate, triethyl phosphate, halides thereof, poly(ethylene glycol), diacrylate, and combinations thereof.

Examples of combinations of the non-aqueous solvents include a combination of a cyclic carbonate and a linear carbonate; a combination of a cyclic carbonate and a lactone; a combination of a cyclic carbonate, a lactone, and a linear ester; a combination of a cyclic carbonate, a linear carbonate, and a lactone, a combination of a cyclic carbonate, a linear carbonate, and an ether; and a combination of a cyclic carbonate, a linear carbonate, and a linear ester. Preferred are the combination of a cyclic carbonate and a linear carbonate, and the combination of a cyclic carbonate, a linear carbonate and a linear ester.

The lithium salt may be selected from a group consisting of LiClO₄, LiPF₆, LiBF₄, LiBOB, LiTFSi; lithium salts including a chain alkyl group such as LiSO₃CF₃, LiN(CF₃SO₂)(C₄F₉SO₂), LiN(CF₃SO₂)₂, LiC(CF₃SO₂)₃, LiN(CF₃CF₂SO₂)₂, LiPF₄(CF₃)₂, LiPF₃(C₂F₅)₃, LiPF₃(CF₃)₃, LiPF₃(iso-C₃F₇)₃ and LiPF₅(iso-C₃F₇), lithium salts including a cyclic alkylene group such as LiN(CF₂)₂(SO₂)₂ and LiN(CF₂)₃(SO₂)₂.

The electrolyte salt may be used singly or in combination. Examples of the preferred combinations include a combination of LiPF₆ with LiBF₄, a combination of LiPF₆ with LiN(SO₂CF₃)₂, and a combination of LiBF₄ with LiN(SO₂CF₃)₂. Most preferred is the combination of LiPF₆ with LiBF₄, though again, these preferential combinations are in no way limiting. There is no specific limitation with respect to the mixing ratio of the two or more electrolyte salts. In the case that LiPF₆ is mixed with other electrolyte salts, the amount of the other electrolyte salts preferably is about 0.01 mole percent or more, about 0.03 mole percent or more, about 0.05 mole percent or more based on the total amount of electrolyte salts. The amount of the other electrolyte salts may be about 45 mole percent or less based on the total amount of the electrolyte salts, about 20 mole percent or less, about 10 mole percent or less, or about 5 mole percent or less. The concentration of the electrolyte salts in the non-aqueous solvent may be about 0.3 M or more, about 0.5 M or more, about 0.7 M or more, or about 0.8 M or more. Further, the electrolyte salt concentration preferably is about 2.5 M or less, about 2.0 M or less, about 1.6 M or less, or about 1.2 M or less.

In some embodiments, the electrolyte may comprise an electrolyte additive 436. For example, inorganic or organic electrolyte additives may be included in the electrolyte. In one example, an inorganic metal salt additive may be included which acts as a barrier between the electrode active material and the electrolyte. For example, the multivalent metal salt may contact the electrochemically active material structures and form a treated surface which operates as a barrier between the active material and other electrolyte components. The multivalent metal salts may include one of the following multivalent metal ions: Ba, Ca, Ce, Cs, Co, Cu, La, Mg, Mn, Ni, Nb, Ag, Ti, Al, Zn, Ur, Pb, Fe, Hg and Gd. The metal ions may be selected based on their reduction potential vs. lithium. For example, the multivalent metal ions may form covalent bonds with oxygen sites available on the surface of the active materials.

In some embodiments, the non-aqueous electrolyte may further comprise an electrolyte additive to reduce flammability. For example, the additive may include a tri-alkyl phosphate. Tri-alkyl phosphates are a flame retardant. In one example, the additive may be trioctylphosphate. The flame retardant may be added from 0.1 to 5 weight percent.

The filled Li-ion cell 420 may then undergo cell formation, referred to also as a first charge/discharge cycle, to form Li-ion cell 422. During cell formation, the electrolyte reacts with the anode comprising the heat-treated polymer coated electrode active material to form a solid electrolyte interface (SEI) layer. Further, during cell formation other reactions, for example additive reactions, may occur. In some embodiments, heat treatment 438 of the Li-ion cell during cell formation may be performed. Heat treatment 438 may affect the kinetics of the battery components reactions. For example, the cells may be exposed to temperatures between 30° C. to 100° C., such as 35° C., 45° C., 60° C., 80° C., or 100° C., for a period of time between 30 minutes to 7 days.

As described in FIG. 4, a lithium-ion battery may be fabricated wherein the heat-treated polymer coated electrode active material is used to prepare an anode. The lithium-ion battery may include a cathode, a separator, an electrolyte, and the anode. The anode may comprise the heat-treated polymer coated electrode active material. The heat-treated polymer coated electrode active material may be prepared by coating the negative electrode active materials, wherein the negative electrode active materials are lithium titanate, with a polymer and then heat-treating the polymer coated negative electrode active materials.

For example, as described above, a non-aqueous electrolyte battery may be provided. The non-aqueous electrolyte battery may comprise an anode comprising a negative electrode active material in contact with an anode current collector and a heat-treated polymer coating on at least a portion of an outer surface of the negative electrode active material. The heat-treated polymer coating may have conjugated ring structures. The non-aqueous electrolyte battery may further comprise a cathode comprising a positive electrode active material in contact with a cathode current collector, a separator positioned between the anode and the cathode, and an electrolyte solution being in ionically conductive contact with the anode and the cathode. The electrolyte comprises at least one salt and at least one solvent.

In one embodiment, the negative electrode active material may be lithium titanate (LTO).

In one embodiment, the heat-treated polymer coating may be heat-treated poly(acrylonitrile).

In another embodiment, the heat-treated polymer coating may be heat-treated parylene.

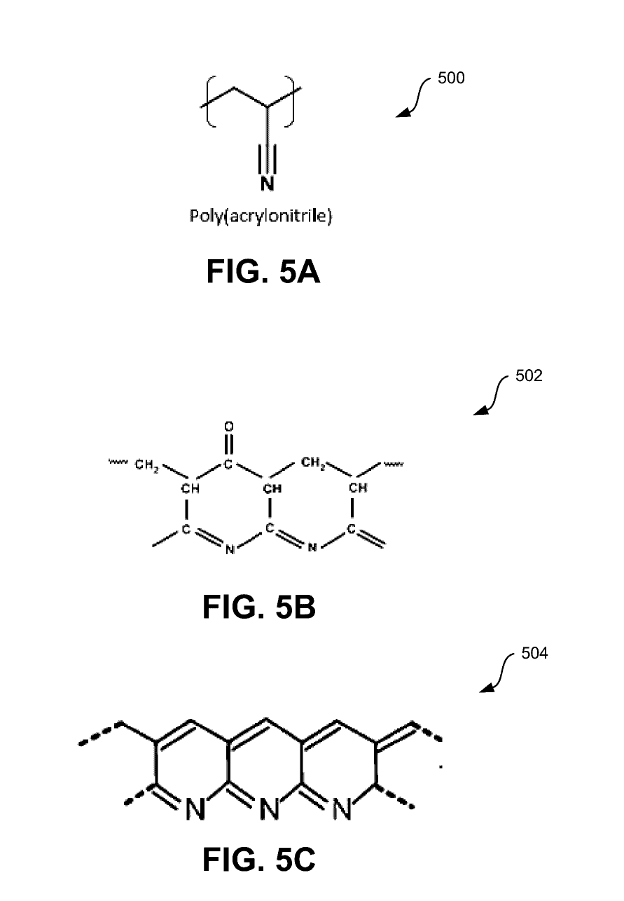

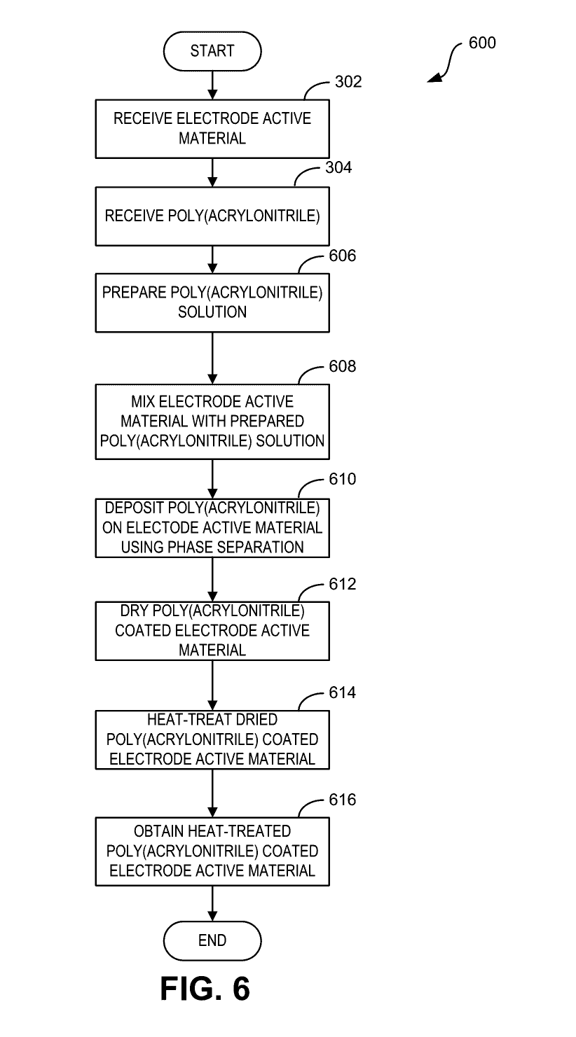

In one example embodiment, a heat-treated polymer coated electrode active material was obtained by coating the surface of LTO with two monolayers of poly(acrylonitrile) (PAN) and then heat-treating the coated LTO in air. In FIG. 5A, the structure of PAN 500 is illustrated. The PAN may be coated as outlined in method 300 above and further illustrated by example method 600 in FIG. 6 using a phase separation approach to coat the PAN on the surface of the LTO electrode active material. The steps which are equivalent to steps described previously in FIG. 3 have the same reference numbers. For example, the PAN may be dissolved in solvent(s) at 606 and mixed with the LTO material at 608 wherein the PAN deposits onto the LTO at the interface formed between the LTO and the solvent(s) 610. The method steps in the phase separation approach may be carried out under continuous agitation, i.e. stirring or mixing. The PAN coated electrode active material may be dried at 612 and the heat-treated at 614. The heat-treated PAN coated electrode active is obtained at 616.

Poly(acrylonitrile) (PAN) forms conjugated ring structures, an example of heat-treated PAN ring structures are illustrated in 502 and 504 of FIGS. 5B and 5C, after exposure to temperature below 400° C. in air. These ring structure are thought to improve the LTO surface electrical conductivity due to aromaticity of the ring network. The presence of nitrogen heteroatoms in the ring system is also believed to facilitate ionic conductivity.

For example, LTO may be coated with PAN via the following procedure. First, PAN may be dissolved in cyclohexane to form 0.5%40% solution. For example, 10 g of PAN may be added to 1L of cyclohexane and stirred until the polymer dissolves. Then 1 kg of LTO may be slowly added, while stirring into the solution. The cyclohexane may then be evaporated at 60° C. to 80° C. to dry the PAN coated LTO to obtain dry PAN coated LTO powder coated. For example, the resulting PAN coated LTO may be dried under vacuum at 80° C. and then subjected to 400° C. heat treatment in air to obtain heat-treated PAN coated electrode active materials. In another example, the resulting PAN coated LTO may be dried under vacuum at 80° C. and then subjected to a 250° C. heat treatment in air to heat-treated the PAN coating on the PAN coated LTO. Thermogravimetric analysis (TGA) may be used to monitor and verify residual surface coverage. The physical properties such as particle size, surface area and tap density of the powder remained the same after the PAN coating and heat-treatment, as evidenced by the SEM images 700 and 802 in FIGS. 7A and 7B respectively. The heat-treated polymer coated electrode active material may comprise a heat-treated polymer coating having a thickness of less than 10 nm. For example, the thickness may be in a range of 0.25 nm to 10 nm.

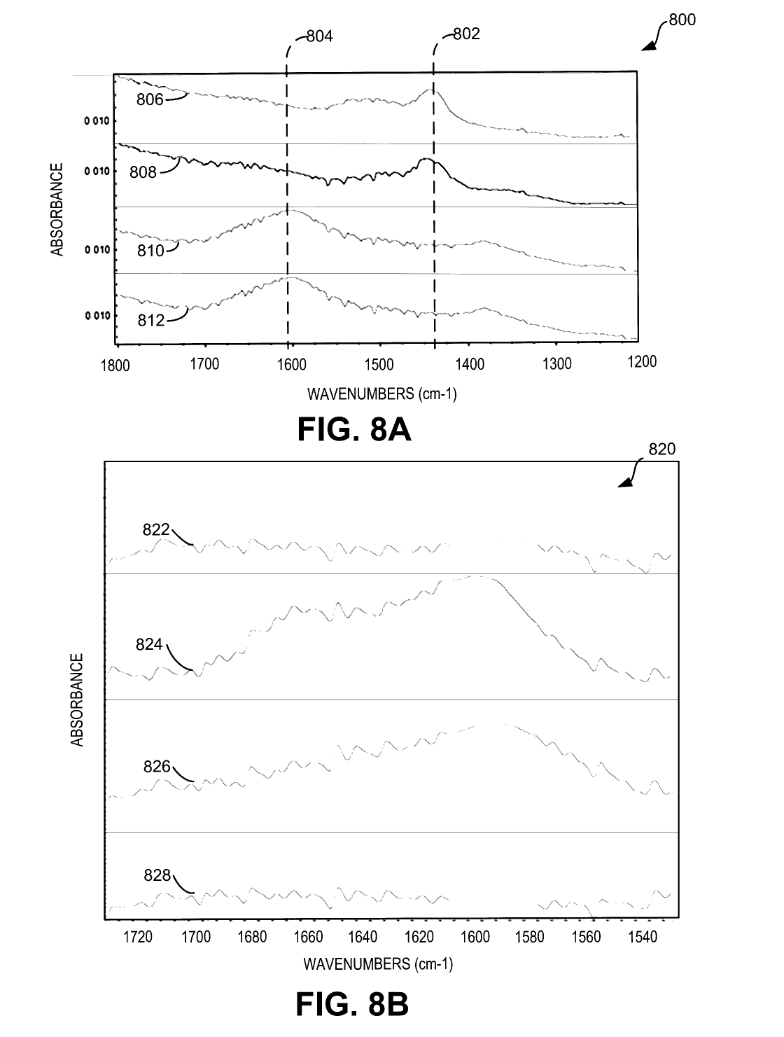

The heat-treated PAN coated LTO may appear as a brown, fine powder. PAN coated LTO heat-treated at higher temperatures, for example at 800° C., may appear as a violet color. The appearance of the violet color may indicate that the Ti on the surface of the LTO was reduced to the Ti³⁺ species. Further, pure heat-treatment of PAN, i.e. complete carbonization results in a black appearance of the resulting powder. Thus, the appearance of the heat-treated PAN coated LTO may indicate the presence of the conjugated ring structures. Further, the appearance of PAN may indicate structural changes, for example as illustrated in the Fourier transform infrared traces 800 and 820 in FIGS. 8A and 8B respectively. The uncoated LTO electrode active material shows distinctive peaks 802, as illustrated by 806. Following coating the LTO with the PAN to form the PAN coated LTO, the same peaks 802 are present as in the uncoated LTO, illustrated by 808. Following heat-treatment of the PAN coated LTO to form the heat-treated PAN coated LTO, peaks 804 which indicate structural changes, which may be attributed to conjugated ring structures, are seen, illustrated in 810, 812, 824, and 826. Thus, the peak at 802 is masked as the heat-treated coating is present on the outer surface of the LTO. Heating the heat-treated PAN coated LTO above the temperature at which heat-treatment occurs, leads to the destruction of structural features, i.e. the conjugated ring structures, of the heat-treated PAN coating, as illustrated in 828.

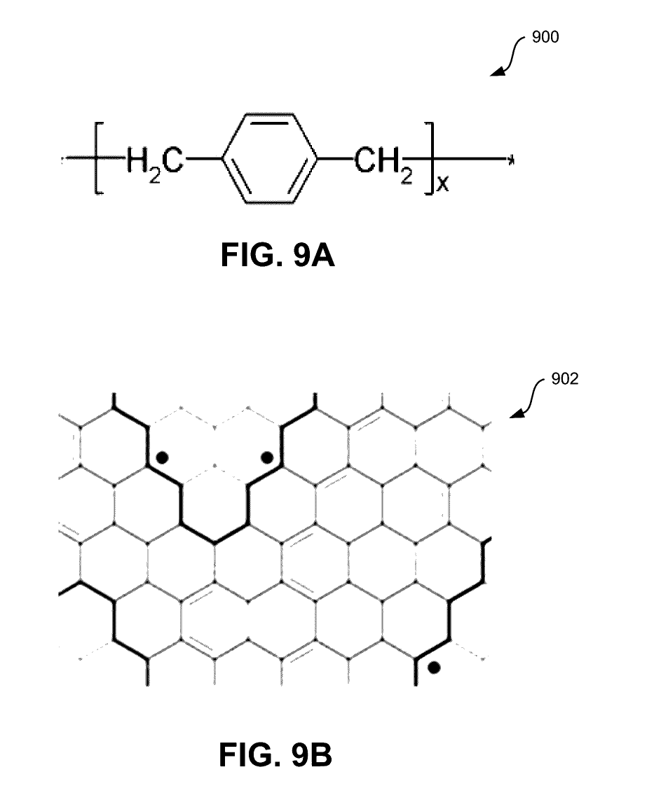

In another example embodiment, a heat-treated polymer coated electrode active material was prepared wherein an LTO surface was coated with a thin conformal coating of parylene and then heat-treated to form a heat-treated parylene coated LTO. The structure of parylene 900 is illustrated in FIG. 9A.

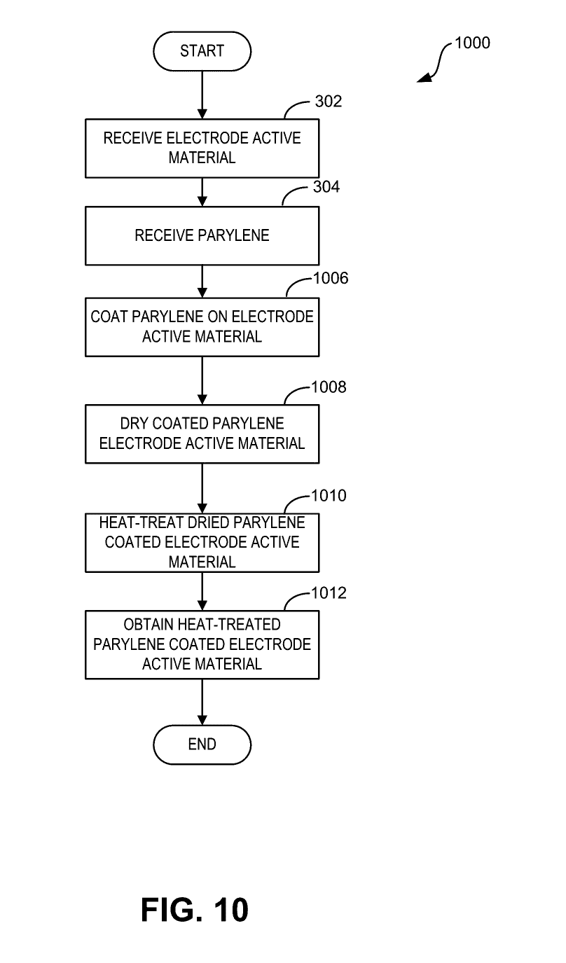

The parylene may be coated as outlined in method 300 above and further illustrated by example method 1000 in FIG. 10 using a gas phase deposition approach to coat the parylene on the surface of the electrode active material. The method steps which are equivalent to method steps previously described in FIG. 3 have the same reference numbers. The method may coat parylene on the electrode active material at 1006, using gas phase deposition. The coated parylene electrode active material may be dried at 1008. The dried parylene coated electrode active material may be heat-treated at 1010 to obtain the heat-treated parylene coated electrode active material at 1012. A proposed structure for heat-treated parylene 902 is illustrated in FIG. 9B, for example graphene type structures.

The parylene may include parylene C, parylene N, or parylene D. The various forms of parylene are commonly used as protective coatings, with no heat-treatment. A parylene coating may be created directly on a surface at room temperature, providing a coating which is effectively stress-free. The parylene coating process may involve no liquid phase. Coatings formed from parylene are truly conformal, of uniform controllable thickness, and pinhole-free at thicknesses greater than 0.5 μm, some recent studies show the coatings may be pinhole-free at thicknesses greater than 1.4 nm. The parylene coating may completely penetrate spaces as narrow as 0.01 mm. This is beneficial to ensure full coverage of active material powder. The parylene may be applied and polymerized without the use of initiators or catalysts for polymerization, so the formed coating is pure and free of trace ionic impurities. Any substrate which is vacuum-stable may be coated using parylene. The parylene coating adheres strongly to a wide variety of materials. Parylene is a chemically and biologically inert and stable compound, making it an excellent barrier material. Parylene is almost completely unaffected by solvents, has a low bulk permeability, and is hydrophobic. Coatings including parylene pass a 100 hour salt-spray test. Non-heat-treated parylene has a low dielectric constant and loss with good high-frequency properties, good dielectric strength; and high bulk and surface resistivity. Parylene has good thermal endurance, for example, parylene C performs in air without significant loss of physical properties for 10 years at 80° C. and in the absence of oxygen to temperature in excess of 200° C. Parylene is also transparent and may be used to coat optical elements. For use in batteries, the insulating properties of parylene would generally not be considered the best match, however, it was unexpectedly found that heat-treated parylene coatings provided protective and electronically conductive properties.

Parylene C is a widely used and provides a useful combination of properties and a low permeability to moisture, chemicals, and other corrosive gases. Parylene N provides high dielectric strength and a dielectric constant that does not vary with changes in frequency. Parylene N is commonly used where greater coating protection is required. Parylene D maintains its physical strength and electrical properties at higher temperatures. Without wishing to be bound by a particular theory, it is believed that halogenated parylenes may be used to coat the electrode active material as the undesired halogen (such as chlorine) may disappear during heat-treatment of the coated electrode active material to form the heat-treated polymer coated electrode active material. For example, some fluorinated parylenes which are commercially available are: parylene AF-4 (generic name, aliphatic fluorination 4 atoms) [parylene SF (AF-4, Kisco product), parylene HT (AF-4, SCS product)] and parylene VT-4 (generic name, fluorine atoms on the aromatic ring) [also parylene CF (VT-4, Kisco product)].

For example, at 1004, a parylene coating may be applied at ambient temperatures with specialized vacuum deposition equipment. Parylene polymer deposition takes place at the molecular level, where films essentially grow a molecule at a time. In one example, a solid, granular raw material of the parylene is heated under vacuum and vaporized into a dimeric gas. The gas is then heated to a temperature to cleave the dimer to its monomeric form. In the room temperature deposition chamber, the monomer gas deposits on all surfaces of the electrode active material as a thin, transparent polymer film, forming a polymer coated electrode active material. For example, the dimer may coat the electrode active material surface and may form a polymer coating, as provided in reactions 1 through 4 previously.

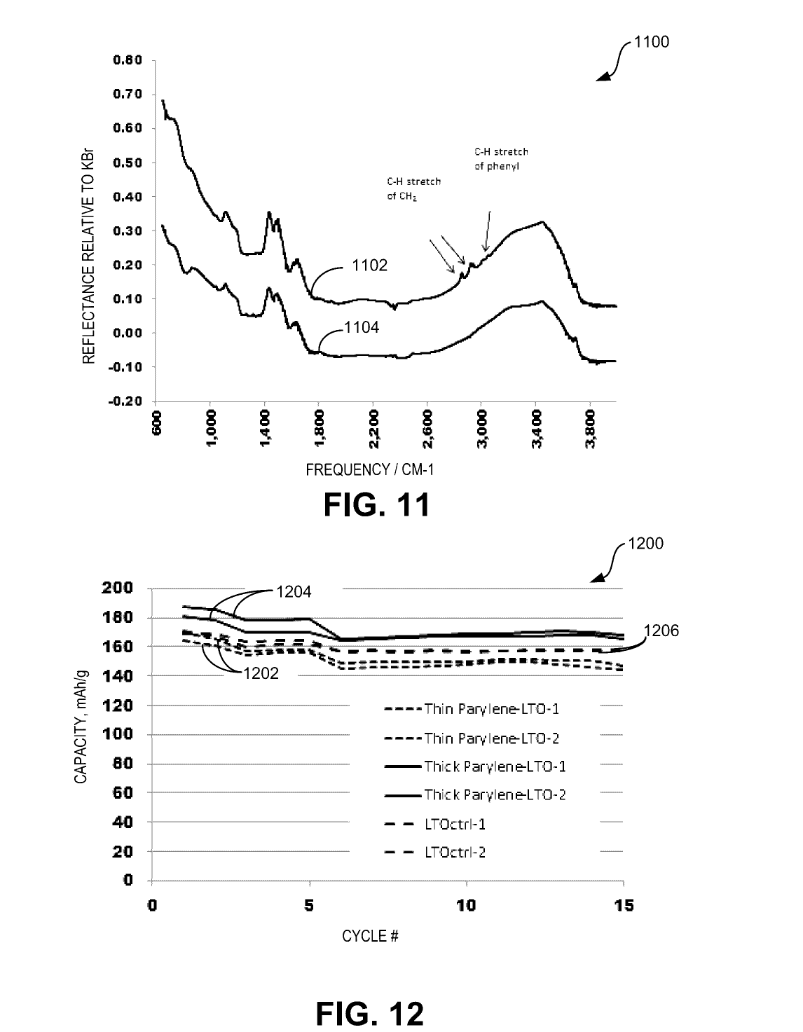

The presence of parylene on the surface of the LTO may be confirmed using Fourier transform infrared spectra 1100, as illustrated in FIG. 11. The parylene coated LTO 1102 shows C—H stretches which are absent from the uncoated LTO 1104. Because parylene is applied as a gas, the coating may penetrate crevices and tight areas on multi-layer components, providing complete and uniform encapsulation. Optimal thickness of the polymer coatings is determined based on the application and the coating properties desired. The parylene coating process may provide an even, conformal surface coating on the LTO.

For example, a Poly-para-Xylylene coating may be formed by the chemical vapor deposition (CVD) process, i.e. gas phase deposition. The coating may be completely pinhole free and the film thickness may be uniformly controlled in the micron range to conform to any irregular shape, whether it has a sharp edge or a complicated internal surface without any thermal stress. The parylene coating is chemically inert, no acid or alkaline material will attack it in any significant manner. The FDA has approved the parylene film for human implantable devices. The parylene film possesses superior dielectric properties, approaching 8000 volts for 1 mm thickness. Parylene coatings may be completely conformal, of uniform thickness, and pinhole free. This is achieved by a unique vapor deposition polymerization process. The advantage of this process is that the coating forms from a gaseous monomer without an intermediate liquid stage. As a result, component configurations with sharp edges, points, flat surfaces, crevices or exposed internal surfaces are coated uniformly without voids. Parylene has no curing cycle, unlike other conformal coating materials. Once deposited, it is ready to go to work. Parylene has a chemical resistance similar to Teflon. For example, parylene resists attack, and is insoluble in all organic solvents up to 150° C. and is resistant to permeation by most solvents with the exception of aromatic hydrocarbons. Since the parylene coating is a high molecular weight, linear, crystalline polymer having an all carbon backbone without any oxygen, nitrogen, or sulfur atom links in the backbone, it is hydrophobic. This carbon backbone, coupled with its substantial crystallinity, makes parylene quite stable and highly resistant to chemical attack. In some examples, the parylene coatings, which are very thin, may have pin-holes. Also, since parylene may not penetrate all the pores of less than 10 μm diameter, some particles of active materials may not be coated. In addition, it is likely that the pores within the secondary particles (which are <1 μm in diameter) may not be completely covered. For example, as shown in capacity measurements 1200 of non-heat-treated parylene coated LTO used in coin cells, the coin cells were functional (i.e. the active material was not totally electronically isolated by the coating), as illustrated in FIG. 12. The coin cells made using a non-heat-treated parylene-coated LTO 1202 and 1204, i.e. the parylene is not heat-treated, had a lower rate capability than the heat-treated parylene coated LTO and showed a similar response to uncoated LTO 1206 control coin cells. The thin parylene coated LTO 1202 had a surface coating of the parylene less than 0.026 microns and the thick parylene coated LTO 1204 had a surface coating of parylene less than 0.086 microns, tabulated in table 1. Thus, applying a coating of parylene to the LTO did not improve the capacity of the electrode active material for use in a cell.

TABLE 1

| sample | surface coating thickness, microns |
|---|---|
| “thick” | <0.086 |
| “thin” | <0.026 |

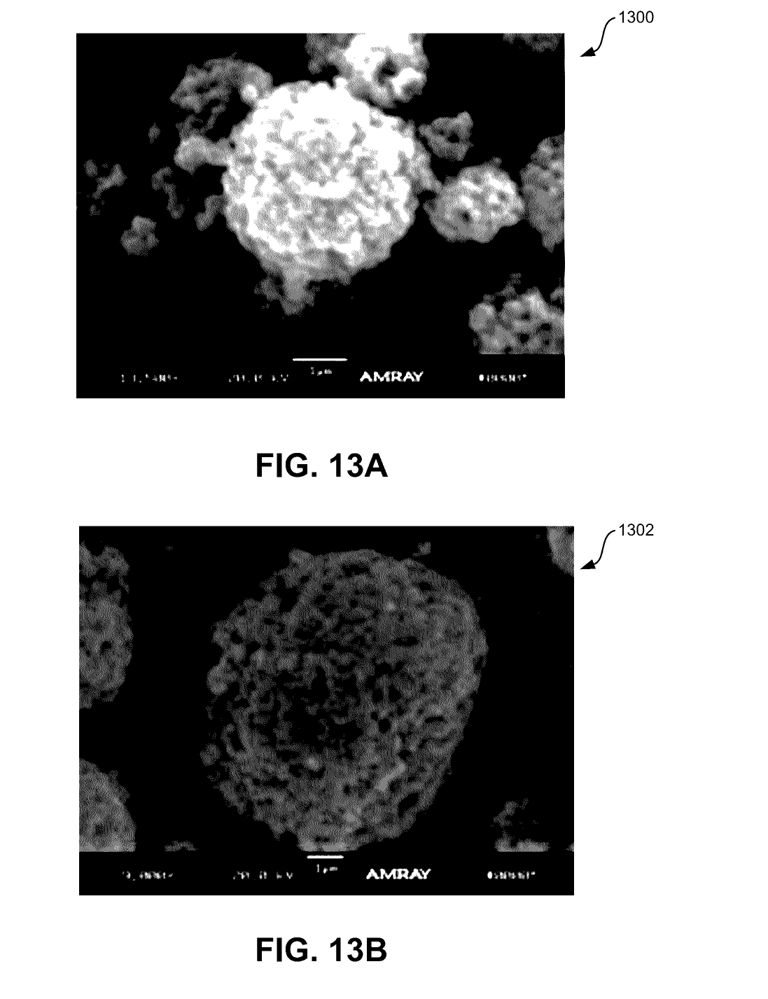

The coating thickness of parylene on the electrode active material may be in a range of 14-25 nm, for example. The coating thickness may be less than 10 nm. The parylene coating applied to the electrode active material may have a minimal or no impact on the material particle size, surface area, or tap density, as provided in Table 2 below. The LTO-150 has no polymer coating and the parylene-LTO-150 has a parylene coating. The particle size, surface area, and tap density are similar. FIGS. 13A and 13B show SEM's of the particles with no polymer coating 1300 in FIG. 13A and with a parylene coating 1302 in FIG. 13B.

TABLE 2

| LTO | D90, microns | BET, m²/g | tap density, g/cc | SEM |
|---|---|---|---|---|
| LTO-150 | 1.66 | 8.60 | 0.80 | same |
| Parylene- | 1.89 | 9.00 | 0.85 | |
| LTO-150 | | | | |

Thus, coating an electrode active material with parylene may provide a coated electrode active material with a reduced number of exposed active sites on the surface of the electrode active material. For example, at a given thickness of <25 nm, Parylene may provide more conformal and complete coverage of the particles than other surface treatments. In other examples, thicker coatings may work. For example, the parylene thickness may be <1 μm, preferably <200 nm, and <50 nm. All of the above relates to parylene coatings that were not heat-treated. Heat-treatment changes the properties of the coating, for example, the heat-treated polymer is graphitic and electrically conductive.

However, in accordance with the current disclosure, it was unexpectedly found that parylene forms a conjugated ring structure upon heat-treatment which provides increased cycle life and capacity retention, and reduced gassing when formed as a heat-treated parylene coated electrode active material. The parylene coated LTO was dried at 80° C. and then heat-treated at 800° C. for 1 hour under argon. The resulting material was off-white in color. The SEM images in FIGS. 14A and 14B showed no observable difference between the starting material, illustrated in FIG. 13A, and the coated material, illustrated in 1400 and 1402, further indicating a thin, even coating of the heat-treated parylene. The heat-treated parylene coating may be less than 10 nm in thickness. For example, the thickness may be in a range of 0.5 nm to 10 nm.

Below, in FIG. 15, a brief description of an electrochemical cell is provided for better understanding of some electrolyte features as well as components that come in contact with electrolyte and expose electrolyte to certain potentials. FIG. 15 illustrates a schematic cross-sectional view of a cylindrical wound cell 1500, in accordance with some embodiments. Positive electrode 1506, negative electrode 1504, and separator strips 1508 may be wound into a jelly roll, which is inserted into a cylindrical case 1502. The jelly roll is a spirally wound assembly of positive electrode 1506, negative electrode 1504, and two separator strips 1508. The jelly roll is formed into a shape of case 1502 and may be cylindrical for cylindrical cells and a flattened oval for prismatic cells. Other types of electrode arrangements include stacked electrodes that may be inserted into a hard case or a flexible case.

The positive electrode 1506, also referred to as a cathode, may be formed by mixing and forming a composition comprising a binder, a conductive additive, solvent, etc. to prepare a slurry wherein the slurry is then coated on a substrate, e.g., a current collector which is then followed by drying to produce the electrode. Further, such electrode materials may be subjected to roll forming or compression molding to be fabricated into a sheet or pellet, respectively. Further, the slurry may comprise non-aqueous liquids, and additives, such as a binder or a conductive additive.

In one example, a positive electrode can be formed by mixing and forming a composition including, by weight, between about 0.01%-15% (e.g., between about 4%-8%) polymer binder, between about 10%-50% (e.g., between about 15%-25%) electrolyte solution as herein described, between about 40%-85% (e.g., between about 65%-75%) electrode-electrode active material, and between about 1%-12% (e.g., between about 4%-8%) conductive additive. Inert filler may also be added up to about 12% by weight, though in certain cases no inert filler is used. Other additives may be included as well.

The negative electrode 1504, also referred to as an anode, may be formed by mixing and forming a composition comprising a binder, a conductive additive, solvent, etc. to prepare a slurry wherein the slurry is then coated on a substrate, e.g., a current collector which is then followed by drying to produce the electrode. Further, such electrode materials may be subjected to roll forming or compression molding to be fabricated into a sheet or pellet, respectively. In one example, the slurry may be coated on both sides of the current collector. In another example, the slurry may be coated on one side of the current collector. Further, the slurry may comprise non-aqueous liquids, and additives, such as a binder or a conductive additive.

The anode may comprise a negative anode active material, herein also referred to as the negative electrode active material or negative electrochemically active material, wherein the anode active material is a lithium-intercalated carbon, lithium metal nitrides such as Li_{2.6}Co_{0.4}N, metallic lithium alloys such as LiAl, Li₄Sn, or lithium-alloy-forming compounds of tin, silicon, antimony, or aluminum. Further included as anode-active materials are metal oxides such as titanium oxides, iron oxides, or tin oxides. For example, the metal oxides may have an empirical formula LixMO₂, where M is a transition metal selected from Mn, Fe, Co, Ni, Al, Mg, Ti, V, Si of a combination thereof, with a layered crystal structure. The value x may be between about 0.01 and about 1, between about 0.5 and about 1, or between about 0.9 and about 1. In another example, the metal oxides may have a formula LiₓM₁ₐM_{2b}M_{3c}O₂, where M1, M2, and M3 are each independently a transition metal selected from the group Mn, Fe, Co, Ni, Al, Mg, Ti, V or Si. The subscripts a, b and c are each independently a real number between about 0 and 1 (0≦a≦1; 0≦b≦1; 0≦c≦1; 0.01≦x≦1), with the proviso that a+b+c is about 1.

The negative electrode active material may be doped with metals such as molybdenum, zirconium or others, or is doped with carbon or carbon nanotubes to increase its electronic conductivity.

In one example, a negative electrode may be formed by mixing and forming a composition including, by weight, between about 2%-20% (e.g., 3%-10%) polymer binder, between about 10%-50% (e.g., between about 14%-28%) electrolyte solution as described herein, between about 40%-80% (e.g., between about 60%-70%) electrode active material, and between about 0%-5% (e.g., between about 1%-4%) conductive additive. In certain embodiments, inert filler may be added up to about 12% by weight, although no filler is used in other cases. Additional additives may also be present.

Suitable binders include, but are not limited to, polymeric binders, particularly gelled polymer electrolytes including polyacrylonitrile, poly(methylmethacrylate), poly(vinyl chloride), and polyvinylidene fluoride, carboxymethylcellulose, and copolymers thereof. Also included are solid polymer electrolytes such as polyether-salt based electrolytes including poly(ethylene oxide)(PEO) and its derivatives, poly(propylene oxide) (PPO) and its derivatives, and poly(organophosphazenes) with ethyleneoxy or other side groups. Other suitable binders include fluorinated ionomers including partially or fully fluorinated polymer backbones, and having pendant groups including fluorinated sulfonate, imide, or methide lithium salts. Specific examples of binders include polyvinylidene fluoride and copolymers thereof with hexafluoropropylene, tetrafluoroethylene, fluorovinyl ethers, such as perfluoromethyl, perfluoroethyl, or perfluoropropyl vinyl ethers; and ionomers including monomer units of polyvinylidene fluoride and monomer units including pendant groups including fluorinated carboxylate, sulfonate, imide, or methide lithium salts. The separator has no particular restriction on the source material or morphology of the separator for the Li-ion cell. Additionally, the separator serves to separate the anode and the cathode so as to avoid their physical contact. The preferred separator has higher porosity, excellent stability against the electrolytic solution, and excellent liquid holding properties. Example material for the separator may be selected from nonwoven fabric or porous film made of polyolefins, such as polyethylene and polypropylene, or ceramic coated materials. The separator is positioned between the anode and the cathode.

The electrolyte (not shown) is supplied into case 1502 prior to sealing cell 1500. The electrolyte soaks into positive electrode 1506, negative electrode 1504, and separator strip 1508, all of which are porous components. The electrolyte provides ionic conductivity between positive electrode 1506 and negative electrode 1504. As such, the electrolyte is exposed to the operating potentials of both electrodes and comes in contact with essentially all internal components of cell 1500. The electrolyte should be stable at these operating potentials and should not damage the internal components.

The electrolyte may comprise Li salt, organic solvents (non-aqueous solvents), such as organic carbonates, and additives. The electrolyte is present throughout the electrochemical cell and in physical contact with the anode, cathode, and separator. The molar concentration of the lithium salt may be between 0.5M and 2.0M.

Case 1502 may be rigid (in particular for lithium-ion cells). Other types of cells may be packed into a flexible, foil-type (polymer laminate) case. For example, pouch cells are typically packed into a flexible case. A variety of materials can be chosen for case 1502. Selection of these materials depends in part on an electrochemical potential to which case 1502 is exposed. More specifically, the selection depends on which electrode, if any, case 1502 is connected to and what the operating potentials are of this electrode.

If case 1502 is connected to positive electrode 1506 of a lithium-ion battery, then case 1502 may be formed from titanium 6-4, other titanium alloys, aluminum, aluminum alloys, and 300-series stainless steel. On the other hand, if case 1502 is connected to negative electrode 1504 of the lithium-ion battery, then case 1502 may be made from titanium, titanium alloys, copper, nickel, lead, and stainless steels. In some embodiments, case 1502 is neutral and may be connected to an auxiliary electrode made, for example, from metallic lithium. An electrical connection between case 1502 and an electrode may be established by a direct contact between case 1502 and this electrode (e.g., an outer wind of the jelly roll), by a tab connected to the electrode and case 1502, and other techniques. Case 1502 may have an integrated bottom. Alternatively, a bottom may be attached to the case by welding, soldering, crimping, and other techniques. The bottom and the case may have the same or different polarities (e.g., when the case is neutral).

The top of case 1502, which is used for insertion of the jelly roll, may be capped with a header assembly that includes a weld plate 1512, a rupture membrane 1514, a washer 1516, header cup 1518, and insulating gasket 1519. Weld plate 1512, rupture membrane 1514, PTC washer 1516, and header cup 1518 are all made from conductive material and are used for conducting electricity between an electrode (negative electrode 1504) and a cell connector. Insulating gasket 1519 is used to support the conductive components of the header and insulate these components from case 1502. Weld plate 1516 may be connected to the electrode by tab 1509. One end of tab 1509 may be welded to the electrode (e.g., ultrasonic or resistance welded), while the other end of tab may be welded to weld plate 1512. Centers of weld plate 1516 and rupture membrane 1518 are connected due to the convex shape of rupture membrane 1514. If the internal pressure of cell 1500 increases (e.g., due to electrolyte decomposition and other outgassing processes), rupture membrane 1518 may change its shape and disconnect from weld plate 1512, thereby breaking the electrical connection between the electrode and the cell connector.

PTC washer 1516 is disposed between edges of rupture membrane 1518 and edges of header cup 1518 effectively interconnecting these two components. At normal operating temperatures, the resistance of PTC washer 1516 is low. However, its resistance increases substantially when PTC washer 1516 is heated up due to, e.g., heat released within cell 1500. PTC washer 1516 is effectively a thermal circuit breaker that can electrically disconnect rupture membrane 1518 from header cup 1518 and, as a result, disconnect the electrode from the cell connector when the temperature of PTC washer 1516 exceeds a certain threshold temperature. In some embodiments, a cell or a battery pack may use a negative thermal coefficient (NTC) safety device in addition to or instead of a PTC device.

Regarding FIGS. 16 through 19, the prepared heat-treated polymer coated electrode active material, for example as previously described, may be used for making an anode. The anode may be coated on one side or on both sides of a current collector. The heat-treated polymer coated electrode active material may comprise a heat-treated polymer coating in direct contact with the electrode active material, wherein the heat-treated polymer coating is present as conjugated ring structures. For example, the heat-treated polymer coating may be adjacent to at least a portion of a surface of the electrode active material. The anode may then be used to make stack plates in pouch cells. The cathode may be a standard matching lithium manganese oxide (LMO) electrode. Control cell were made for comparison wherein the electrode active material had no heat-treated polymer coating (uncoated electrode active material). The properties of the cells were measured as described below. The heat-treated polymer coated electrode active materials were made into cells, described in further detail below, using heat-treated poly(acrylonitrile) coated LTO and heat-treated parylene coated LTO. The cells were assembled with a lithium manganese oxide (LMO) cathode and a lithium titanate (LTO) anode.

For example, the control cell with uncoated LTO may be prepared using LTO powder as received to fabricate an electrode with no heat-treated polymer coating.

Regarding FIGS. 16 through 19, the cycle life data for the capacity retention of the Li-ion cells at both 40° C. and 50° C. were performed using the 1C rate for charge and the 1C rate for discharge. The cut off voltages were 1.5V and 2.7V.

Regarding FIGS. 16 and 17, electrodes were prepared with the heat-treated polymer coated electrode active material. In this example, electrodes were prepared with the heat-treated poly(acrylonitrile) (PAN) coated lithium titanate (PAN-LTO). 0.9 Ah cells were built with a matching LMO cathode. The cells were cycled at 40° C. and 50° C. and compared with a control cell having the exact same cell design but built with an uncoated LTO (bare LTO) anode.

Two cells were made with bare LTO and two cells were made with the PAN-LTO. They were then charged to 100% SOC and stored at 50° C. for 28 days. The cell with uncoated LTO swelled, showing an increase of 43% in thickness, while the cell the PAN-LTO swelled to a lesser extent, showing an increase of only 7% in thickness, tabulated in Table 3.

TABLE 3

| LTO treatment | Swelling after 28 days |
|---|---|
| none | 43% |
| Pyrolyzed PAN | 7% |

Thus, the PAN-LTO reduced swelling of the cells by at least 35%. The heat-treated PAN coating may block the electrolyte from interacting with the surface of the electrode active material.

Turning to FIG. 16, capacity retention of a Li-ion cell 1600 at 40° C. including a heat-treated poly(acrylonitrile) coated electrode active material is shown. The cell containing an anode comprising PAN-LTO 1602 shows about a 5% to 10% better capacity retention in comparison to the control cells 1604.

Turning to FIG. 17, capacity retention of a Li-ion cell 1700 at 50° C. including a heat-treated poly(acrylonitrile) coated electrode active material is shown. The cell containing an anode comprising PAN-LTO 1702 shows about a 5% to 10% better capacity retention in comparison to the control cells 1704.

In both the 40° C. and 50° C. cycling tests shown in FIGS. 16 and 17, the PAN-LTO cycled with less fade during the first 100 cycles in comparison to the uncoated LTO. Poly(acrylonitrile) (PAN) forms conjugated ring structures after exposure to temperature below 400° C. in air. These ring structure are thought to improve the LTO surface electrical conductivity due to aromaticity of the ring network. The presence of nitrogen heteroatoms in the ring system is also believed to facilitate ionic conductivity.

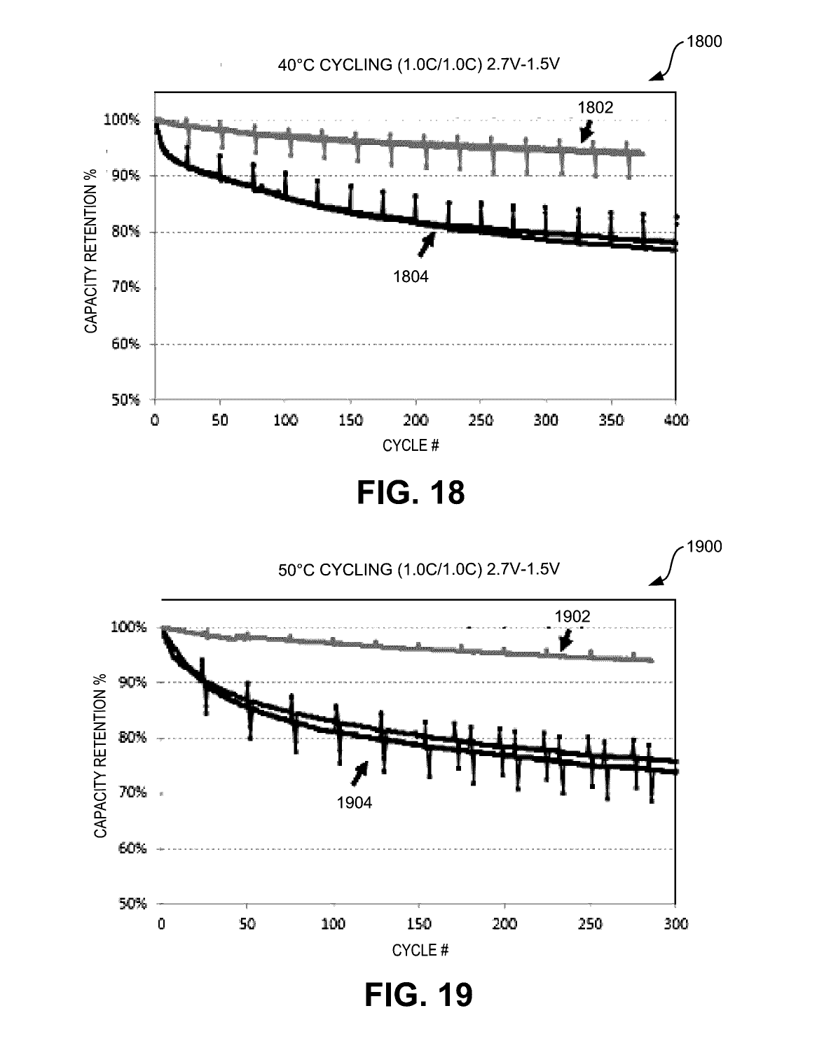

Regarding FIGS. 18 and 19, electrodes were prepared with the heat-treated polymer coated electrode active material. In this example, electrodes were prepared with the heat-treated parylene coated lithium titanate (PAR-LTO). 0.9 Ah cells were built with matching LMO cathodes. The cells were cycled at 40° C. and 50° C. and compared with a control cell having the exact same cell design but built with an uncoated LTO (bare LTO) anode.

Two cells were made with bare LTO and two cells were made with the heat-treated PAR-LTO. They were then charged to 100% SOC and stored at 50° C. for 28 days. The cell with uncoated LTO swelled 43% in thickness, while the cell the PAR-LTO increased in thickness by only 9%, tabulated in Table 4.

TABLE 4

| LTO treatment | Swelling after 28 days |
|---|---|
| None | 43% |
| Heat-treated parylene | 9% |

Thus, the PAR-LTO reduced swelling of the cells by at least 30%. The heat-treated polymer coating on the surface of the electrode active material may inhibit electrolyte degradation pathways, for example as described previously, by blocking the electrolyte components from the surface of the electrode active material.

Turning to FIG. 18, capacity retention of a Li-ion cell 1800 at 40° C. including a heat-treated parylene coated electrode active material is shown. The cell containing an anode comprising PAN-LTO 1802 shows about a 15% better capacity retention in comparison to the control cells 1804.

Turning to FIG. 19, capacity retention of a Li-ion cell 1900 at 50° C. including a heat-treated parylene coated electrode active material is shown. The cell containing an anode comprising PAR-LTO 1902 shows about a 15% better capacity retention in comparison to the control cells 1904.

The results show a significant improvement in capacity retention at 40° C. and 50° C. with the heat-treated parylene coated LTO in comparison to the uncoated LTO. As discussed above regarding the PAN-LTO, the PAR-LTO forms a regular ring structure upon heat treatment, for example a conjugated ring structure such as a conjugated graphene type structure, on the surface of the electrode active material, which unexpectedly improves the cycle life and capacity retention, and reduces gassing.

The conjugated ring structure formed as a coating from a heat-treated polymer improves the capacity retention and reduces swelling in Li-ion cells in comparison to uncoated LTO. The heat-treated polymer coated electrode active material may act as a barrier between the electrolyte components and the electrode active material surface to reduce electrolyte decomposition while allowing lithium-ions through.

Also provided herein are battery packs, each containing one or more electrochemical cells built with processed electrode active materials. When a battery pack includes multiple cells, these cells may be configured in series, in parallel, or in various combinations of these two connection schemes. In addition to cells and interconnects (electrical leads), battery packs may include charge/discharge control systems, temperature sensors, current balancing systems, and other like components. For example, battery regulators may be used to keep the peak voltage of each individual cell below its maximum value so as to allow weaker batteries to be fully charged, thereby bringing the whole pack back into balance. Active balancing can also be performed by battery balancer devices that can shuttle energy from stronger batteries to weaker ones in real time for improved balance.

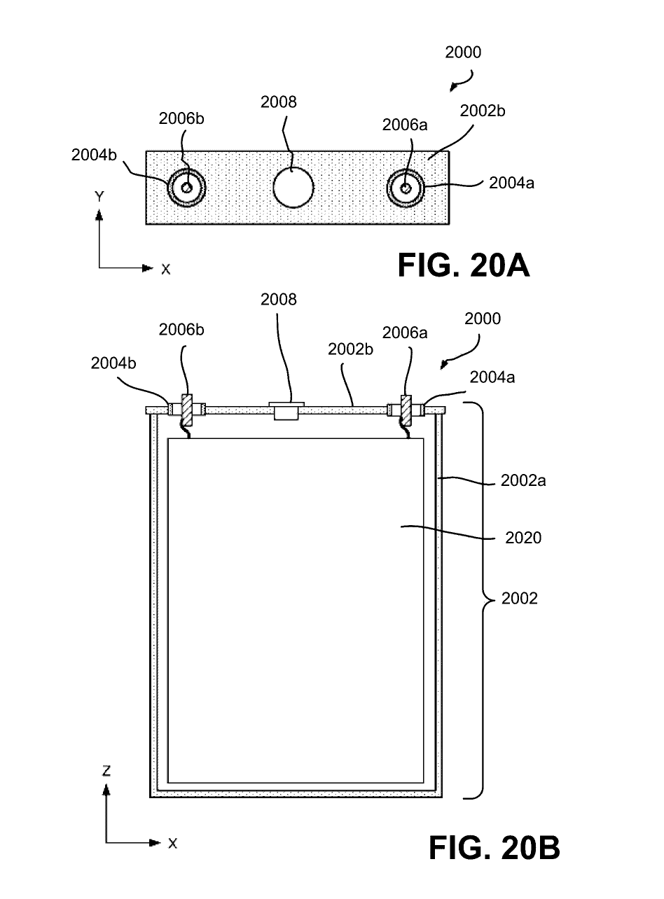

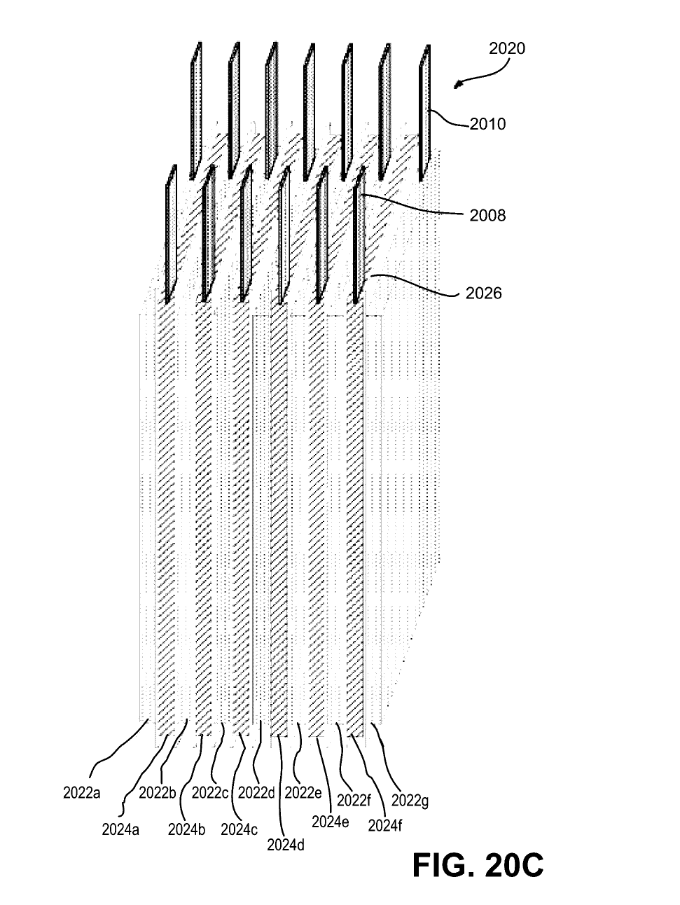

Turning to FIGS. 20A and 20B, a schematic top and side view of a prismatic electrochemical cell 2000 are illustrated respectively, in accordance with certain embodiments. Electrochemical cell 2000 includes an enclosure assembly 2002 that surrounds and encloses an electrode assembly 2020. Enclosure assembly 2002 is shown to include a case 2002a and header 2002b attached to case 2002a. Enclosure assembly 2020 may include other components, such as a case bottom, various seals and insulating gaskets, which are not specifically shown in FIGS. 20A and 20B.

Header 2002b is shown to include feed-throughs 2004a and 2004b and venting device 2008. One of these components may be used as a fill plug. Feed-throughs 2004a and 2004b include corresponding conductive elements 2006a and 2006b that provide electronic communication to respective electrodes in electrode assembly 2020 as further described with reference to FIG. 20C. In certain embodiments, external components of conductive elements 2006a and 2006b may be used as cell terminals for making electrical connections to the battery. Conductive elements 2006a and 2006b may be insulated from header 2002b. In other embodiments, header 2002b and/or case 2002a may provide one or both electronic paths to the electrodes in electrode assembly 2020. In some embodiments, a cell may have only one feed-through or no feed-through at all.

In certain embodiments (not shown), the feed-through and/or venting device may be supported by other components of enclosure assembly 2002, such as the case and/or bottom. Further, the feed-through and/or venting device may be integrated into a header or other components of the enclosure assembly during fabrication of these components or during assembly of the cell. The latter case allows more flexibility in design and production.

Components of enclosure assembly 2002 may be made from electrically insulating materials, such as various polymers and plastics. These materials need to be mechanically/chemically/electrochemically stable at the specific operating conditions of the cell, including but not limited to electrolytes, operating temperature ranges, and internal pressure build-ups. Some examples of such materials include polyamine, polyethylene, polypropylene, polyimide, polyvinylidene fluoride, polytetrafluoroethylene, and polyethylene terephthalate. Other polymers and copolymers may be used as well. In certain embodiments, components of enclosure assembly 2002 may be made from conductive materials. In these embodiments, one or more components may be used to provide electronic communication to the electrodes. When multiple conductive components are used for enclosure assembly 2002, these conductive components may be insulated with respect to each other using insulating gaskets.

Conductive elements 2006a and 2006b may be made of various conductive materials such as any metal of metallic alloy. These conductive materials may be isolated from any contact with electrolyte (e.g., external components or components having protective sheaths) and/or electrochemically stable at operating potentials if exposed to electrolyte. Some examples of conductive materials include steel, nickel, aluminum, nickel, copper, lead, zinc and their alloys.

When enclosure assembly 2002 includes multiple components, such as case 2002a and header 2002b, these components may be sealed with respect to each other. The sealing process used depends on the materials used for the components, and may involve heat sealing, adhesive application (e.g., epoxies), and/or welding (e.g., laser welding, ultrasonic welding, etc.). This sealing is performed after inserting electrode assembly 2020 into enclosure assembly 2002 and typically prior to filling electrolyte into enclosure assembly 2002. Enclosure assembly 2002 may be then sealed by installing venting device 2008 or some other means. However, in certain embodiments the sealing may occur before electrolyte is introduced into the enclosure assembly 2002. In such embodiments, the enclosure assembly should provide a mechanism for filling electrolyte after such sealing has taken place. In one example, the enclosure assembly 2002 includes a filling hole and plug (not shown).

Electrode assembly 2020 includes at least one cathode and one anode. These two types of electrodes are typically arranged such that they face one another and extend alongside one another within the enclosure assembly 2002. A separator may be provided between two adjacent electrodes to provide electric insulation while also allowing ionic mobility between the two electrodes through pores in the separator. The ionic mobility is provided by electrolyte that soaks the electrodes and separator.

The electrodes are typically much thinner than the internal spacing of enclosure assembly 2002. In order to fill this space, electrodes may be arranged into stack and/or jelly rolls. In a jelly roll, one cathode and one anode are wound around the same axis (in the case of round cells) or around an elongated shape (in the case of prismatic cells). Each electrode has one or more current collecting tabs extending from that electrode to one of conductive elements 2006a and 2006b of feed-throughs 2004a and 2004b, or to some other conductive component or components for transmitting an electrical current to the electrical terminals of the cell.

In a stackable cell configuration, multiple cathodes and anodes may be arranged as parallel alternating layer. One example of a stackable electrode assembly 2020 is shown in FIG. 20C. Electrode assembly 2020 is shown to include seven cathodes 2022a-2022g and six anodes 2024a-2024f. Adjacent cathodes and anodes are separated by separator sheets 2026 to electrically insulate the adjacent electrodes while providing ionic communication between these electrodes. Each electrode may include a conductive substrate (e.g., metal foil) and one or two electrode active material layers, for example, the surface-treated electrode active material described above, supported by the conductive substrate. Each negative electrode active material layer is paired with one positive electrode active material layer. In the example presented in FIG. 20C, outer cathodes 2022a and 2022g include only one positive electrode active material facing towards the center of assembly 1620. All other cathodes and anodes have two electrode active material layers. One having ordinary skill in the art would understand that any number of electrodes and pairing of electrodes may be used. Conductive tabs may be used to provide electronic communication between electrodes and conductive elements, for example. In certain embodiments, each electrode in electrode assembly 2020 has its own tab. Specifically, electrodes 2022a-2022g are shown to have positive tabs 2010 while anodes 2024a-2024f are shown to have negative tabs 2008.

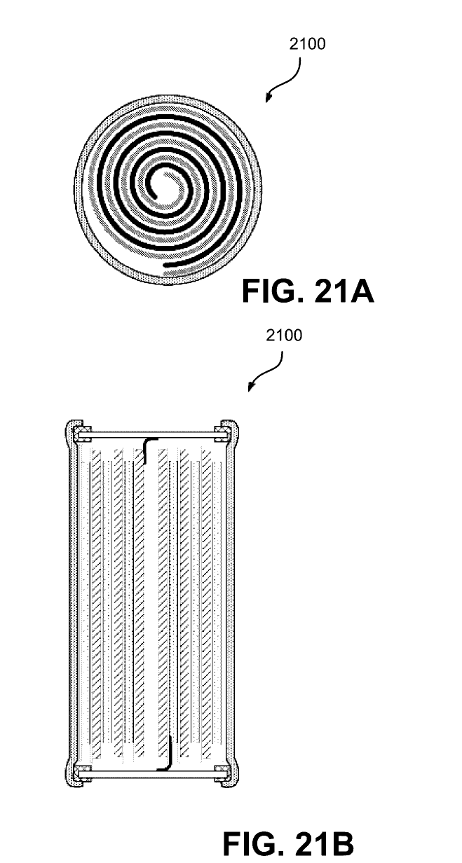

FIGS. 21A and 21B illustrate a schematic top and side view of a wound electrochemical cell example 2100, in which two electrodes are wound into a jelly roll, in accordance with certain embodiments.

For example, a heat-treated polymer coated electrode active material for use in a lithium-ion battery is provided. The heat-treated polymer coated electrode active material may comprise a negative electrode active material and a heat-treated polymer coating. The heat-treated polymer coating may be directly adjacent to the negative electrode active material, for example in direct contact with the outer surface of the negative electrode active material. The heat-treated polymer coating may have conjugated ring structures which improves the electronic conductivity of the heat-treated polymer coated electrode active material. The negative electrode active material may be a lithiated metal oxide. For example, the negative electrode active material may be lithium titanate. The heat-treated polymer coated electrode active material may have a heat-treated polymer coating having a thickness less than 10 nm. The heat-treated polymer coating may be heat-treated poly(acrylonitrile) in one example or heat-treated parylene in another example. The electrode active material may remain unchanged during the coating and subsequent heat-treatment process to form the heat-treated polymer coated electrode active material.

Various modifications of the present invention, in addition to those shown and described herein, will be apparent to those skilled in the art of the above description. Such modifications are also intended to fall within the scope of the appended claims.

It is appreciated that all reagents are obtainable by sources known in the art unless otherwise specified.

Patents, publications, and applications mentioned in the specification are indicative of the levels of those skilled in the art to which the invention pertains. These patents, publications, and applications are incorporated herein by reference to the same extent as if each individual patent, publication, or application was specifically and individually incorporated herein by reference.

The foregoing description is illustrative of particular embodiments of the invention, but is not meant to be a limitation upon the practice thereof.

The foregoing discussion should be understood as illustrative and should not be considered limiting in any sense. While the inventions have been particularly shown and described with references to preferred embodiments thereof, it will be understood by those skilled in the art that various changes in form and details may be made therein without departing from the spirit and scope of the inventions as defined by the claims.

The corresponding structures, materials, acts and equivalents of all means or steps plus function elements in the claims below are intended to include any structure, material or acts for performing the functions in combination with other claimed elements as specifically claimed.

Finally, it will be understood that the articles, systems, and methods described hereinabove are embodiments of this disclosure—non-limiting examples for which numerous variations and extensions are contemplated as well. Accordingly, this disclosure includes all novel and non-obvious combinations and sub-combinations of the articles, systems, and methods disclosed herein, as well as any and all equivalents thereof.

1. A heat-treated polymer coated electrode active material for use in a lithium-ion battery, comprising:
a negative electrode active material;
a heat-treated polymer coating wherein the heat-treated polymer coating is directly adjacent to the negative electrode active material; and
the heat-treated polymer coating having conjugated ring structures.

2. The heat-treated polymer coated electrode active material of claim 1, wherein the negative electrode active material is lithium titanate.

3. The heat-treated polymer coated electrode active material of claim 1, wherein the heat-treated polymer coating has a thickness less than 10 nm.

4. The heat-treated polymer coated electrode active material of claim 1, wherein the heat-treated polymer coating is heat-treated poly(acrylonitrile).

5. The heat-treated polymer coated electrode active material of claim 1, wherein the heat-treated polymer coating is heat-treated parylene.

6. A non-aqueous electrolyte battery, comprising:
an anode comprising a negative electrode active material in contact with an anode current collector and a heat-treated polymer coating on at least a portion of an outer surface of the negative electrode active material, the heat-treated polymer coating having conjugated ring structures;
a cathode comprising a positive electrode active material in contact with a cathode current collector;
a separator positioned between the anode and the cathode; and
an electrolyte solution being in ionically conductive contact with the anode and the cathode, the electrolyte comprising at least one salt and at least one solvent.

7. The non-aqueous electrolyte battery of claim 6, wherein the negative electrode active material is lithium titanate.

8. The non-aqueous electrolyte battery of claim 6, wherein the heat-treated polymer coating is heat-treated poly(acrylonitrile).

9. The non-aqueous electrolyte battery of claim 6, wherein the heat-treated polymer coating is heat-treated parylene.

10. A method for preparing a surface-treated electrode active material, comprising:
receiving an electrode active material;
receiving a polymer;
coating the polymer on the electrode active material to form a polymer coated electrode active material; and
heat-treating the polymer coated electrode active material to form a heat-treated polymer coated electrode active material.

11. The method of claim 10, wherein the electrode active material is lithium titanate.

12. The method of claim 10, wherein the heat-treated polymer has a conjugated ring structure.

13. The method of claim 10, wherein heat-treating the polymer coated electrode active material is done at a temperature less than 600° C.

14. The method of claim 10, wherein the polymer is poly(acrylonitrile).

15. The method of claim 10, wherein the polymer is parylene.

16. The method of claim 10, wherein heat-treating the polymer coated electrode active material is done in air.

17. The method of claim 10, wherein coating the polymer on the electrode active material is done by phase separation.

18. The method of claim 10, wherein coating the polymer on the electrode active material is done by gas phase deposition.

19. The method of claim 10, further comprising:
drying the polymer coated electrode active material prior to heat-treating the polymer coated electrode active material.

20. The method of claim 19, further comprising:
preparing a slurry comprising the heat-treated polymer coated electrode active material wherein the slurry further comprises a polymer binder selected from the group consisting of polyacrylonitrile, poly(methylmethacrylate), poly(vinyl chloride), polyvinylidene fluoride, poly(vinylidene fluoride-co-hexafluoropropene), polyacrylic acid, styrene butadiene rubber, carboxymethylcellulose and copolymers thereof;
coating the slurry onto a current collector; and
drying the slurry on the current collector, thereby forming an anode.

21. The method of claim 20, further comprising:
fabricating a lithium-ion battery, comprising:
the anode;
a cathode;
a separator positioned between the anode and the cathode; and
an electrolyte being in ionically conductive contact with the anode and the cathode, the electrolyte comprising at least one salt and at least one non-aqueous solvent.
